(19) United States
(12) Patent Application Publication
(10) Pub. No.: US 2008/0069618 A1
(43) Pub. Date: Mar. 20, 2008

(54) Image forming apparatus and image forming method

(76) Inventors: Masahito Ishino, Osaka (JP); Norio Tomiie, Osaka (JP); Katsuya Ota, Osaka (JP); Chikara Ishihara, Osaka (JP); Yuki Matsui, Osaka (JP)

Correspondence Address: ARTHUR G. SCHAIER;CARMODY & TORRANCE LLP, 50 LEAVENWORTH STREET, P.O. BOX 1110, WATERBURY, CT, 06721, US

(21) Appl. No.: 11/899,019

(22) Filed: Sep. 4, 2007

(30) Foreign Application Priority Data
Sep. 15, 2006 (JP) 2006-250549

(51) Int. Cl. G03G 21/12

(52) U.S. Cl. 399/360

(57) ABSTRACT

The invention provides an image forming apparatus that, even when a dynamic friction coefficient of a latent image carrier has a value more than a predetermined value, can prevent a toner in the cleaning device from excessively charging and an air gap from occurring while efficiently recovering a residual toner while efficiently recovering a residual toner, and thereby can effectively prevent the black spots due to the leakage current from the cleaning device from occurring; and an image forming method therewith. There are provided an image forming apparatus that includes a cleaning device provided with a rotation member for cleaning a surface of a latent image carrier with a titanium oxide contained in a toner and an image forming method therewith, wherein a dynamic friction coefficient of the latent image carrier is set to a value in the range of 0.3 to 0.7 and a specific resistance of the titanium oxide is set to a value in the range of 1×10⁰ to 1×10² Ω·cm.

### BACKGROUND OF THE INVENTION

1. Field of the Invention

The present invention relates to an image forming apparatus and an image forming method. In particular, the invention relates to an image forming apparatus that, even when a dynamic friction coefficient of a latent image carrier is in a predetermined range, can effectively prevent a black spot from occurring while efficiently recovering a residual toner, and an image forming method therewith.

2. Description of the Related Art

Conventionally, in an image forming method according to an electrophotographic process that is used in a copying machine or a printer, an electrophotographic photoconductor (photoconductor drum) is widely used as a latent image carrier. A general image forming method that uses such an electrophotographic photoconductor is carried out as follows.

That is, a surface of an electrophotographic photoconductor is charged to a predetermined potential by use of a charging means, followed by illuminating light from a LED light source by use of an exposure means to optically attenuate the potential of an exposed part to form an electrostatic latent image corresponding to an original image. Next, the electrostatic latent image is developed by a developing means to form a toner image on a surface of an electrophotographic photoconductor. Finally, the electrophotographic photoconductor is brought into contact with or closer to the transfer means to transfer the toner image on an intermediate transfer body or paper.

On the other hand, in the image forming method like this, it is known that on a surface of an electrophotographic photoconductor after transferring, a toner that does not take part in the image formation and is called a residual toner. In this connection, a process of making the surface roughness of an electrophotographic photoconductor smaller is applied in order to make such a residual toner difficult to adhere.

However, when the surface roughness of an electrophotographic photoconductor is made small to some extent, a dynamic friction coefficient of the surface of the electrophotographic photoconductor maybe larger corresponding thereto. Furthermore, as an image forming operation is repeated, the dynamic friction coefficient is larger in some cases. As a result, there is a problem in that the recovering efficiency of the residual toner is deteriorated.

In order to overcome such problems, there is proposed a method in which, in addition to adding a slight amount of a polishing agent to a toner to be used, a polishing roller and a cleaning blade are used together to remove a residual toner on a surface of an electrophotographic photoconductor (for example, Patent Documents 1 and 2).

More specifically, Patent Document 1 discloses an image forming method where, with a toner containing a polishing agent and an amorphous silicon drum as a photoconductor, the toner is developed by a developing means and transferred and a surface of the amorphous silicon drum is polished and cleaned by a slide friction roller. In this method, an elastic layer that captures the polishing agent is provided on a surface of the slide friction roller to capture the polishing agent in the toner by the elastic layer, and the captured polishing agent polishes and cleanses a drum surface.

On the other hand, Patent Document 2 discloses an image forming apparatus that includes a photoconductor; a slide friction roller that friction slides on a surface of the photoconductor through a toner; a scraping member that scrapes the toner off the surface of the photoconductor; and a toner transfer means for transferring the toner scraped by the scraping member in parallel along an axial direction of the slide friction roller, wherein a toner transfer rate at an intermediate part in the axial direction of the slide friction roller is set slower in the speed than a transfer rate in both end parts in the axial direction of the slide friction roller.
[Patent Document 1] JP10-63157A (claims and FIG. 1)
[Patent Document 2] JP2005-49620A (claims and FIG. 1)

However, in the image forming methods described in Patent Documents 1 and 2, charging of the toner in the cleaning device is not particularly considered. Accordingly, a toner stored in the cleaning device tends to be charged excessively owing to friction with a cleaning blade or a polishing roller. As a result, a phenomenon in which charges accumulated in the toner in the neighborhood of the cleaning blade abruptly discharge to be a leakage current to flow toward the surface of the electrophotographic photoconductor, is found.

Consequently, there is a problem that owing to such a leakage current, the surface of the electrophotographic photoconductor is damaged to generate a black spot in a formed image.

In particular, in a case of adopting a method where a toner carried on a surface of an electrostatic latent image carrier is transferred to a transfer body from its downward position (hereinafter, in some cases, referred to as a downward transfer method), the toner stored in the cleaning device, and the polishing roller and the electrophotographic photoconductor are always in contact under friction: accordingly, excessive charging in such a toner tends to remarkably appear.

When adopting such a downward transfer method, observed is a phenomenon that an air gap that may cause the abrupt discharge tends to occur between the toner in the neighborhood of the cleaning blade and the surface of the electrophotographic photoconductor. As a consequence, there is a problem that, owing to charges accumulated in the toner in the neighborhood of the cleaning blade, a leakage current more tends to occur to further increase black spots.

### SUMMARY OF THE INVENTION

In view of this situation, the inventors of the present invention have made earnest studies concerning the above problems, and as a result, found that, even when a dynamic friction coefficient of a latent image carrier is in a predetermined range, excessive charging of a toner in a cleaning device and generation of an air gap can be effectively suppressed while efficiently recovering a residual toner by setting a specific resistance of a titanium oxide as a polishing agent in a predetermined range, thereby to complete the present invention.

That is, an object of the present invention is to provide an image forming apparatus that, even when a dynamic friction coefficient of a latent image carrier is within a predetermined range, can suppress excessive charging of a toner in a cleaning device and generation of an air gap from occurring while efficiently recovering a residual toner, and thereby can effectively prevent occurrence of black spots due to a leakage current from the cleaning device, and a image forming method therewith.

According to one aspect of the present invention, there is provided an image forming apparatus that includes a cleaning device provided with a rotation member for cleaning a surface of a latent image carrier with a titanium oxide contained in a toner, wherein a dynamic friction coefficient of the latent image carrier is set to a value in the range of 0.3 to 0.7 and a specific resistance of the titanium oxide is set to a value in the range of 1×10⁰ to 1×10² Ω·cm, and therefore, the foregoing problems can be solved.

That is, when the specific resistance of the titanium oxide is set in a predetermined range, the toner in the cleaning device can be effectively prevented from excessively charging.

Since, by setting the specific resistance of the titanium oxide in a predetermined range, toner particles and additives remaining on the surface of the latent image carrier can be efficiently recovered in the cleaning device to make it easy to control compositions of toner particles and additives in the toner in the cleaning device. As a result, an air gap can be effectively prevented from occurring between the toner and the latent image carrier in the cleaning device, whereby the abrupt discharge can be prevented from occurring between the toner in the cleaning device and the surface of the latent image carrier.

Accordingly, it is possible to, even when the dynamic friction coefficient of the latent image carrier is within a predetermined range, effectively suppress occurrence of the leakage current between the cleaning device and the latent image carrier and black spots in a formed image caused by the leakage current, while efficiently recovering the residual toner.

When the image forming apparatus of the invention is constituted, it is preferable that when it is assumed that a fluorescent X-ray intensity of the titanium oxide in the toner before use is X1 and a fluorescent X-ray intensity of the titanium oxide in the toner in the cleaning device is X2, the X1 and the X2 satisfy a relational expression (1) below.

X2/X1≧1.4 (1)

This constitution makes it possible to effectively prevent the air gap generated between the toner in the neighborhood of the cleaning blade in the cleaning device and the latent image carrier from occurring.

Accordingly, the toner in the neighborhood of the cleaning blade can be prevented from excessively charging and thereby the leakage current can be prevented from occurring, resulting in effectively preventing occurrence of the black spot due to the leakage current.

The relational expression (1) is sufficient when the relational expression (1) is satisfied at least at any one of a start time of the image forming apparatus and a predetermined time during an operation thereof.

More specifically, with a power supply switch of the image forming apparatus turned on, values of X1 and X2 can be directly measured, or, alternative characteristics of the fluorescent X-ray intensity are measured to indirectly confirm to satisfy.

It suffices that the relational expression (1) is confirmed to be satisfied when, at an arbitrary time during an operation of the image forming apparatus, the toners are sampled and values of X1 and X2 are directly measured or alternative characteristics of the fluorescent X-ray intensity are measured to indirectly measure values of X1 and X2. Here, an arbitrary time during an operation of the image forming apparatus is, for example, a time when 10 to 60 sec has elapsed after a power supply switch of the image forming apparatus is turned on or an arbitrary time up to printing 10 to 100,000 sheets of A4-size sheets.

However, as a reference measurement time of the fluorescent X-ray intensity, a time point when 1000 sheets of A4-size are printed is selected. At this time, it is preferable that the toner in the cleaning device is sampled, a value of X2 is directly measured by use of a fluorescent X-ray analyzer and compared with a fluorescent X-ray intensity (X1) of the titanium oxide in the toner before use to confirm whether the relational expression (1) is satisfied or not.

Further, when the image forming apparatus of the invention is constituted, an additional amount of the titanium oxide is preferably set to a value in the range of 0.1 to 5 parts by weight with respect to 100 parts by weight of toner particles.

With this constitution, while the relational expression (1) can be readily satisfied, a polishing effect of the surface of the electrophotographic photoconductor can be effectively exerted.

Furthermore, when the image forming apparatus of the invention is configured, a center line average surface roughness (Ra) of the latent image carrier measured based on JIS B0601 is preferably set to a value in the range of 0.010 to 0.040 μm.

This constitution enables reduction of the residual toner slipping through the cleaning means to improve the recovering efficiency of the residual toner.

When the image forming apparatus of the invention is constituted, the latent image carrier is preferably an amorphous-silicon photoconductor.

This constitution makes it possible to readily control surface characteristics such as the dynamic friction coefficient and the center line average surface roughness of the surface of the latent image carrier within predetermined ranges.

In addition, since a photosensitive layer has adequate hardness, the polishing effect in a cleaning process can be more effectively exerted. This allows a constant high quality image formation to be carried out over a long term.

Furthermore, when the image forming apparatus of the invention is constituted, a toner carried on the surface of the latent image carrier is preferably transferred to a transfer body from its downward position.

When thus the toner is transferred to the transfer body from its downward position, it is, in general, expected that an air gap is generated and occurrence frequency of black spots caused by a leakage current increase in comparison with a case where a toner is transferred from upward. However, in the case of the image forming apparatus of the invention, such black spots can be effectively prevented from occurring even when the toner is transferred from its downward position. That is, it is possible to effectively suppress an air gap formed between the toner in the neighborhood of the cleaning blade and the latent image carrier from occurring, so that black spots due to the leakage current can be effectively prevented from occurring.

When the image forming apparatus of the invention is constituted, the cleaning device preferably has a toner receiving member for storing the toner scraped off the latent image carrier.

With this constitution, even when a downward transfer method is adopted, the toner can be sufficiently carried by the rotation member or the like in the cleaning device.

According to another aspect of the invention, there is provided an image forming method that includes a step in which a rotation member of a cleaning device cleanses a surface of a latent image carrier by use of a titanium oxide contained in the toner, wherein a dynamic friction coefficient of the latent image carrier is set to a value in the range of 0.3 to 0.7 and a specific resistance of the titanium oxide is set to a value in the range of 1×10⁰ to 1×10² Ω·cm.

That is, the image forming method has an advantage as follows. Even when the dynamic friction coefficient of the latent image carrier is within a predetermined range, excessive charging in the toner in the cleaning device and air gap therein can be prevented from occurring while efficiently recovering the residual toner. This makes it possible to effectively suppress occurrence of a leakage current from the toner in the cleaning device to a surface of the latent image carrier and black spots caused thereby.

Moreover, when the image forming method of the invention is applied, a toner carried on the surface of the latent image carrier is preferably transferred to a transfer body from its downward position.

Even when thus carried out, the black spots caused by a leakage current can be effectively prevented from occurring.

### BRIEF DESCRIPTION OF THE DRAWINGS

FIG. 1 is a diagram for explaining a fundamental structure of an image forming apparatus;

FIG. 2 is a diagram for explaining an image forming part including a developing device and a cleaning device;

FIGS. 3A and 3B are diagrams for explaining an embodiment of an electrophotographic photoconductor;

FIG. 4 is a diagram for explaining a method of measuring a dynamic friction coefficient;

FIG. 5 is a diagram for explaining a fundamental structure of the cleaning device;

FIG. 6 is a view for explaining a toner receiving member;

FIG. 7 is a graph for explaining relationship between a specific resistance of titanium oxide and occurrence frequency of black spots;

FIG. 8 is an exemplary chart of elemental analysis that uses a fluorescence X-ray analyzer (first one);

FIG. 9 is an exemplary chart of elemental analysis that uses a fluorescence X-ray analyzer (second one);

FIGS. 10A to 10C are diagrams for explaining a state of an air gap and a situation when black spots are generated;

FIGS. 11A and 11B are diagrams for explaining a leakage current measurement system and its exemplary measurement chart;

FIG. 12 is a graph for explaining a relationship between a magnitude of an air gap and a potential difference between a toner layer and a photoconductor drum;

FIG. 13 is a graph for explaining a relationship between a content of an additive and a potential difference between a toner layer and a photoconductor drum; and

FIG. 14 is a graph for explaining a relationship between a fluorescent X-ray intensity ratio (X1/X2) and occurrence frequency of black spots.

### DESCRIPTION OF THE PREFERRED EMBODIMENT

An aspect of the invention is an image forming apparatus that includes a cleaning device provided with a rotation member for cleaning a surface of a latent image carrier by use of a titanium oxide contained in a toner, wherein a dynamic friction coefficient of the latent image carrier is set to a value in the range of 0.3 to 0.7 and a specific resistance of the titanium oxide is set to a value in the range of 1×10⁰ to 1×10² Ω·cm.

Another aspect of the invention is an image forming method that includes a step in which a rotation member of a cleaning device cleanses a surface of a latent image carrier by use of the titanium oxide contained in a toner, wherein a dynamic friction coefficient of the latent image carrier is set to a value in the range of 0.3 to 0.7 and a specific resistance of the titanium oxide is set to a value in the range of 1×10⁰ to 1×10² Ω·cm.

Hereinbelow, the image forming apparatus and the image forming method of the invention will be specifically described appropriately with reference to the drawings.

### 1. Fundamental Constitution of Image Forming Apparatus

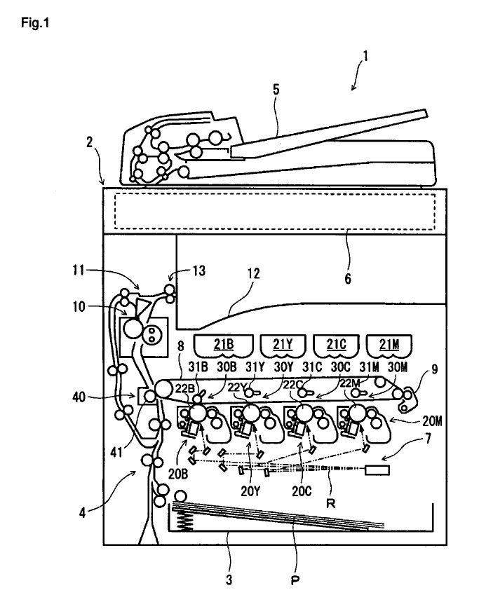

FIG. 1 is a front view in a vertical section of an image forming apparatus 1. The image forming apparatus 1 is a color printing image forming apparatus that adopts an intermediate transfer method and transfers a toner image on a paper. The image forming apparatus 1 also adopts a method where toners carried on surfaces of electrophotographic photoconductors (hereinafter, in some cases, referred to as photoconductor drums) 22B, 22Y, 22C and 22M as latent image carriers are transferred to an intermediate transfer belt 8 as a transfer body from its downward position (hereinafter, in some cases, referred to as a downward transfer process).

Thus, adopting the downward transfer method allows to maintain high image quality and to arrange a black image forming part that is frequently used nearest to a secondary transfer position, whereby a first copy time can be shortened.

On the other hand, when the downward transfer method is adopted like this, in comparison with a case where a toner is transferred to a transfer body from an upper side, that is, an upward transfer method is adopted, a phenomenon is generated that the toner in the cleaning device tends to be excessively charged from a structural reason. Accordingly, in some cases, the black spots due to the leakage current from the toner in the cleaning device tend to be generated.

By contrast, in the image forming apparatus of the invention, the toner in the cleaning device can be effectively prevented from excessively charging and an air gap is effectively prevented from occurring between the toner and a latent image carrier.

Therefore, the image forming apparatus of the invention can effectively prevent occurrence of the leakage current between the toner in the cleaning apparatus and the latent image carrier and the black spots in a formed image, which are due to the leakage current.

Now, the image forming apparatus as the invention will be specifically described as for the respective constituent elements with a case of adopting the downward transfer method as an example.

As shown in FIG. 1, inside and on lower side of a body 2 of the image forming apparatus 1, a paper cassette 3 is arranged. Inside of the paper cassette 3, papers P such as cut papers before print are stacked and stored. Then, the papers P are separated one by one and conveyed to a left upper side of the paper cassette 3. Further, the paper cassette 3 can be drawn level from a front side of the body 2.

A paper conveying part 4 is provided inside of the body 2 and on the left side of the paper cassette 3. The paper P delivered out of the paper cassette 3 is conveyed by the paper conveying part 4 vertically upward along the side surface of the body 2 to reach a secondary transfer part 40.

On the other hand, an original feeding part 5 is arranged on a top surface of the image forming apparatus 1, and an original image reader 6 is arranged below the original feeding part 5. When a user makes a copy of an original, an original where characters, figures and patterns are depicted is placed on the original feeding part 5.

Next, the original feeding part 5 separates originals one by one and sends out, and the original image reader 6 reads image data thereof. Then, information on the image data is transmitted to a laser illuminator 7 that is an exposure device arranged on the upper side of the paper cassette 3. Subsequently, the laser illuminator 7 illuminates laser light R controlled based on the image data to an image forming part 20.

Furthermore, image forming parts 20, four in total, are arranged on the upper side of the laser illuminator 7. Further on the upper side of the respective image forming parts 20, an intermediate transfer belt 8 is arranged where an intermediate transfer body is used in a form of an endless belt. The intermediate transfer belt 8 is wound around and supported by a plurality of rollers and rotated by a driving device (not shown) in a clockwise direction in FIG. 1.

Still furthermore, the four image forming parts 20 (20M, 20C, 20Y and 20B) are arranged in series from an upstream side in a rotation direction of the intermediate belt 8 to a downstream side thereof. The four image forming parts 20 are, in order from an upstream side, a magenta image forming part 20M, a cyan image forming part 20C, a yellow image forming part 20Y and a black image forming part 20B.

In order to replenish a toner, toner feeders 21M, 21C, 21Y and 21B corresponding to the image forming parts 20M, 20C, 20Y and 20B are arranged on the upper side of the intermediate transfer belt 8, and the toner is supplied to the respective image forming parts 20 by the transport means (not shown).

In the description below, unless necessary to be particularly restricted, identification marks “M”, “C”, “Y” and “B” that show colors of the toners are omitted.

Subsequently, in the respective image forming parts 20, the laser light R is illuminated from the laser illuminator 7 that is an exposure device to generate an electrostatic latent image of an original image. Accordingly, a toner image is formed corresponding to the electrostatic latent image. Furthermore, on the upper side of the respective image forming parts 20, a primary transfer part 30 including a primary transfer roller 31 is arranged across the intermediate transfer belt 8.

The primary transfer roller 31 is movable in an up and down direction in FIG. 1 and, as needs arise, can be brought into pressure contact with or separated from the intermediate transfer belt 8. As the primary transfer roller 31 is brought into contact under pressure with the intermediate transfer belt 8, the intermediate transfer belt 8 is brought into contact under pressure with the image forming part 20 from the upper side to transfer a toner image formed by the image forming part 20 on the surface of the intermediate transfer belt 8. Subsequently, as the intermediate transfer belt 8 rotates, the toner images of the respective image forming parts 20 are transferred on the intermediate transfer belt 8 at a predetermined timing.

As a consequence, a color toner image where toner images of four colors of magenta, cyan, yellow and black are superposed is formed on the surface of the intermediate transfer belt 8.

At a place where the intermediate transfer belt 8 meets a paper transport path, the secondary transfer part 40 is arranged. The secondary transfer part 40 is provided with a secondary transfer roller 41. The color toner image on the surface of the intermediate transfer belt 8 is transferred on the paper P conveyed in synchronization by the paper conveying part 4 at a nip part that is formed by bringing the intermediate transfer belt 8 and the secondary transfer roller 41 into contact under pressure. Subsequently, the toner remaining on the surface of the intermediate transfer belt 8 after the secondary transfer is cleaned by a cleaning device 9 of the intermediate transfer belt 8, which is arranged on an upstream side in a direction of rotation of the magenta image forming part 20M relative to the intermediate transfer belt 8.

A fixing part 10 is arranged on the upper side of the secondary transfer part 40. At the secondary transfer part 40, the paper P carrying an undeveloped toner image is conveyed to the fixing part 10. Accordingly, the toner image is heated and pressurized and fixed by using a fixing roller and a pressure roller.

A branched part 11 is arranged on the upper side of the fixing part 10. The paper P ejected from the fixing part 10, when it is not printed on both sides, is ejected from the branched part 11 into a housed paper ejection tray 12 of the image forming apparatus 1.

An ejection port from which papers P are ejected from the branched part 11 to the housed paper ejection tray 12 works as a switchback part 13. When both surfaces are printed, a transport direction of the paper P ejected from the fixing part 10 is switched at the switchback part 13. As a result, the paper P is conveyed through the branched part 11, a left side of the fixing part 10 and a left side of the secondary transfer part 40 to the lower side and conveyed once more through the paper conveying part 4 to the secondary transfer part 40.

### 2. Image Forming Part

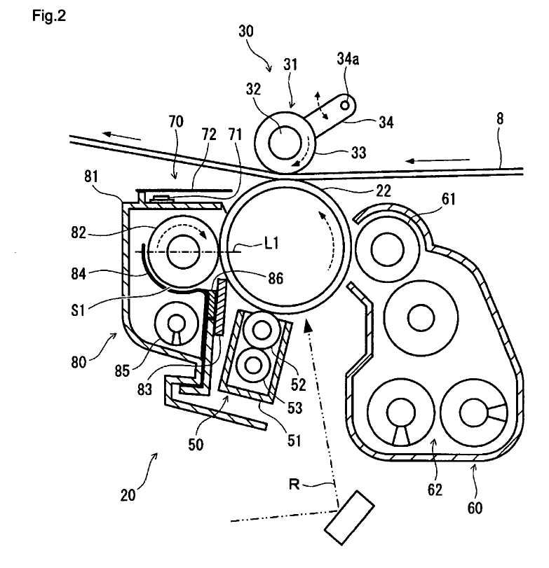

Next, the image forming part 20 will be further detailed with reference to FIG. 2. Since the respective image forming parts 20 (20M, 20C, 20Y and 20B) that use the toners of four colors of magenta, cyan, yellow and black) are common in structure, description will be given without restricting a toner color.

Here, as shown in FIG. 2, the image forming part 20 has, at a center thereof, a photoconductor drum 22 that is a latent image carrier. A charging device 50, a developing device 60, a charge elimination device 70 and a cleaning device 80 are arranged in this order in the neighborhood of the photoconductor drum 22 along a rotation direction thereof. The primary transfer part 30 is arranged along a rotation direction of the photoconductor drum 22 between the developing device 60 and the charge elimination device 70.

Hereinbelow, the image forming part 20 in the image forming apparatus 1 of the invention is divided into the latent image carrier (photoconductor drum), the charging device, the developing device, the charge elimination device and the cleaning device, and each thereof will be specifically described.

### (1) Latent Image Carrier

Preferable examples of the photoconductor drum 22 as a latent image carrier include an organic photoconductor provided with a photosensitive layer made of a polycarbonate resin containing a charge generating agent and a charge transfer agent that are organic compounds, and an inorganic photoconductor provided with a photosensitive layer made of a-Si or a-Se that is an inorganic-type charge generating agent.

This is because when the latent image carrier is made of an organic photoconductor, the latent image carrier can be readily produced to be economical. However, since the organic photoconductor is poor in the endurance in comparison with the inorganic photoconductor, the inorganic photoconductor, in particular, an amorphous-silicon photoconductor is preferably used in the image forming apparatus of the invention.

That is because, when an amorphous-silicon photoconductor is adopted, surface characteristics such as the dynamic friction coefficient and the center line average surface roughness on the surface of the amorphous-silicon photoconductor can be readily controlled within a predetermined range by use of a producing method described below, for example.

Further, that is because, since the photosensitive layer has adequate hardness, the polishing effect in a cleaning process described below can be effectively exerted. Accordingly, when an amorphous silicon (hereinafter, in some cases, described as a-Si) photoreceptor is used, a constant high quality image can be formed over a long term.

In the following description, an amorphous-silicon photoconductor will be described as an example.

### (1)-1 Fundamental Constitution

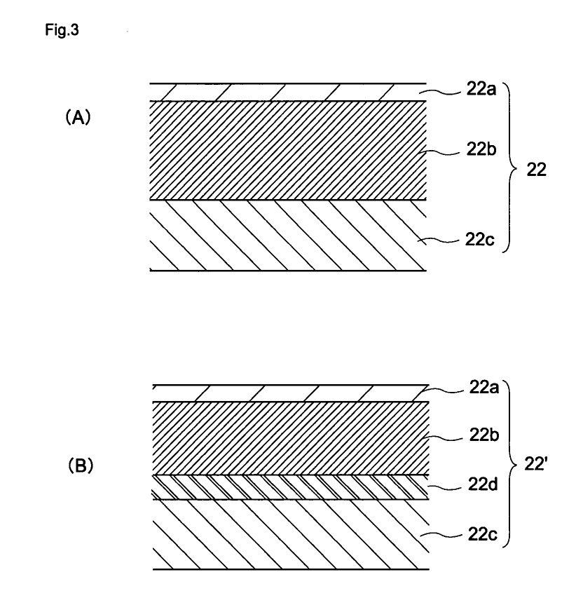

A fundamental constitution of the amorphous-silicon photoconductor as the photoconductor drum 22 is preferable in which, as shown in FIG. 3A, at least a photoconductive layer 22b and a surface protective layer 22a are sequentially laminated on a base body 22c.

This is because when the photoconductive layer 22b having predetermined surface characteristics is formed and further thereon the surface protective layer 22a is formed, amorphous-silicon photoconductors having predetermined surface characteristics can be stably obtained.

This is also because, when such a surface protective layer 22a is arranged, a surface polishing amount can be suppressed, and even under a high temperature and high humidity environment, the image deletion can be prevented from occurring, so that a function of the photoconductive layer 22b can be effectively exerted.

Further, as shown in FIG. 3B, a photoconductor drum 22′ is more preferably configured such that a charge injection inhibiting layer 22d made of a-Si base material is arranged on a base body 22c, and a photoconductive layer 22b and a surface protective layer 22a are sequentially laminated via the charge injection inhibiting layer 22d.

### (1)-2 Base Body

As the base body 22c in the photoconductor drum 22, preferably used are electroconductive members made of metals such as aluminum, stainless, zinc, copper, iron, titanium, nickel, chromium, tantalum, tin, gold and silver and alloys thereof. Also usable are base bodies obtained by forming, on a surface of an insulator such as resin, glass or ceramics, an electroconductive film made of the metal or a transparent conductive material such as ITO and SnO₂ by means of the vapor-deposition.

Among these, an aluminum alloy is particularly preferred. This is because when an a-Si base material is used as a material of a photoconductive layer and a charge injection inhibiting layer, which will be described below, the adhesiveness with the layers can be improved and the weight saving and the cost saving can be obtained.

### (1)-3 Photoconductive Layer

A photoconductive layer constituted of a-Si or a-Si including an element such as C, O or N added thereto is preferably used since an electrophotographic photoconductor excellent in the photoconductivity, high-speed responsiveness, repetition stability, heat resistance and endurance can be obtained.

Specific examples of such a-Si base materials include a-Si, a-SiC, a-SiN, a-SiO, a-SiGe, a-SiCN, a-SiNO, a-SiCO and a-SiCNO.

The a-Si base materials can be layered as a photoconductive layer by means of a plasma CVD method that employs, for example, a glow discharge decomposition method or an ECR method, a photo-induced CVD method, a catalyst CVD method and a reactive vapor-deposition method. When such a photoconductive layer is formed, hydrogen or a halogen element such as fluorine or chlorine is preferably added in the range of 1 to 40 atomic percent for dangling bond termination.

The photoconductive layer may preferably contain a IIIa group element in a periodic table (hereinafter, abbreviated as IIIa group element) or a Va group element in a periodic table (hereinafter, abbreviated as Va group element) or an element such as C, N and O.

This is because controlling contents of the elements allows appropriate adjustment of electric characteristics such as dark conductivity and photoconductivity and an optical band gap in the photoconductive layer.

Specific examples of the IIIa group element and Va group element include boron (B) and phosphorus (P), respectively.

This is because since such elements are excellent in the covalent bonding properties, the semiconductor characteristics in the photoconductive layer can be readily controlled and excellent photosensitivity can be obtained as well.

The content of the IIIa group element, when it is contained together with an element such as C, N or O, is preferably a value in the range of 0.1 to 20,000 ppm to an entirety of the photoconductive layer. On the other hand, when an element such as C, N or O is not contained or is contained only slightly, the content of the IIIa group element is preferably set to a value in the range of 0.01 to 200 ppm to an entirety of the photoconductive layer.

The content of the Va group element, when it is contained together with an element such as C, N or O, is preferably set to a value in the range of 0.1 to 10,000 ppm to an entirety of the photoconductive layer. On the other hand, when an element such as C, N or O is not contained or is contained only slightly, the content of the Va group element is preferably set to a value in the range of 0.01 to 100 ppm to an entirety of the photoconductive layer.

As to an inclusion concentration of the elements, a concentration gradient in a layer thickness direction may be arranged. In that case, it suffices that an average content in the entire photoconductive layer is within the above-mentioned range.

The a-Si system material preferably contains microcrystalline silicon (μc-Si).

This is because when a photoconductive layer contains the μc-Si, the dark conductivity and the photoconductivity can be improved to thereby improve degrees of freedom in designing a photoconductive layer.

The μc-Si may be formed by use of a method similar to the method which is used for forming a photoconductive layer with an a-Si system material, for example, a glow discharge decomposition method, and by adequately controlling a layering condition.

More specifically, in the case of, for example, a glow discharge decomposition method being used, a temperature of a base that is a target of layering is set slightly higher, a high frequency power is set slightly higher and a hydrogen flow rate as a dilution gas is increased, whereby the μc-Si can be formed.

Even when a photoconductive layer containing the μc-Si is formed, an impurity element can be contained similarly to the above description.

A film thickness of the photoconductive layer is preferably appropriately controlled depending on a photoconductive material to be used and desired electrophotography characteristics. The film thickness is preferably a value in the range of 5 to 100 μm and more preferably a value in the range of 10 to 80 μm.

Next, a method of producing the photoconductive layer will be described.

First, preferable examples of a method of forming a photoconductive layer made of a-Si include a plasma CVD method that employs, for example, a glow discharge decomposition method or an ECR method, a photo-induced CVD method, a catalyst CVD method and a reactive vapor-deposition method. A plasma CVD method can be preferably used.

This is because, by making use of ion impact among the plasma in the plasma CVD method, irregularities caused by nucleus growth generated in an initial stage in the formation of a photoconductive layer made of a-Si can be made smaller. As a result, the surface roughness in a photoconductive layer can be made a small value such as mentioned above.

Accordingly, even when a film thickness of a photoconductive layer formed is a value equal to 10 μm or more, the irregularity in a surface thereof can be suppressed to obtain excellent smoothness. As a result, even when, for example, a surface layer made of a-SiC is formed with a thickness of substantially 1 μm on the photoconductive layer, excellent smoothness on the surface of the surface layer can be obtained.

### (1)-4 Surface Layer

As the surface layer, a-SiC and a-SiN etc. can be preferably used.

This is because such a material has adequate friction characteristics, and thus, a latent image carrier provided with predetermined surface characteristics can be readily obtained together with the smoothness of a surface layer described below.

This is also because, when such a material is used, light can be transmitted to a photoconductive layer without excessively absorbing light illuminated on an electrophotographic photoconductor and the material allows an electrostatic latent image in an image forming process to be sufficiently maintained since it has a resistance value in the range of 1×10¹¹ to 1×10¹² Ω·cm².

Furthermore, that is because the material has a high hardness to provide sufficient resistance properties against the slide friction due to a polishing roller or the like.

Now, an example where a-SiC is used as a material will be specifically described about the surface layer.

The surface characteristics such as the dynamic friction coefficient and the surface roughness of a surface layer are synonymous with the surface characteristics of a latent image carrier. Accordingly, descriptions of the surface characteristics of the surface layer can be applied as well to an inorganic photoconductor and an organic photoconductor, which do not have a surface layer.

In the beginning, a surface layer made of the a-SiC can be formed in such a manner that a Si-containing gas such as SiH₄ (silane gas) and a C-containing gas such as CH₄ (methane gas) are mixed and, similarly to the photoconductive layer, decomposed by a glow discharge decomposition method.

A composition ratio of Si and C in the surface layer can be controlled by varying a mixing ratio of the Si-containing gas and C-containing gas.

To the photoconductive layer, in the beginning, preferably laminated is a first a-SiC layer relatively high in a Si ratio, which has a value of x in the range of 0 to 0.8 when a-SiC is expressed as a-Si₁₋ₓCₓ:H. Next, on the first layer, preferably laminated is a second a-SiC layer relatively high in a C ratio, which has a value of x in the range of 0.95 to 1.0 when a-SiC is expressed as a-Si₁₋ₓCₓ:H.

This is because, when the C ratio in a surface side of the surface layer is heightened, the image deletion under high temperature and high humidity environment can be prevented from occurring.

That is, when the C ratio on a surface side of the surface layer is heightened, it is possible to effectively prevent a layer surface from oxidizing due to ozone etc. generated owing to the corona discharge, which prevents the hygroscopicity from becoming excessively high and also effectively prevents the image deletion from occurring under high temperature and high humidity environment.

A film thickness of the first a-SiC layer is preferably set to a value in the range of 0.1 to 2 μm.

This is because, when the film thickness of the first a-SiC layer is set to a value in such the range, influences on the pressure resistance, film strength and residual potential can be maintained in an excellent state.

Accordingly, the film thickness of the first a-SiC layer is more preferably set to a value in the range of 0.2 to 1 μm and further more preferably set to a value in the range of 0.3 to 0.8 μm.

Further, a film thickness of the second a-SiC layer is preferably set to a value in the range of 0.01 to 2 μm.

This is because, when the film thickness of the second a-SiC layer is set to a value in the range, influences on the pressure resistance, film strength, wear resistance and residual potential can be maintained in an excellent state.

Accordingly, the film thickness of the second a-SiC layer is more preferably set to a value in the range of 0.02 to 1 μm and further more preferably set to a value in the range of 0.05 to 0.8 μm.

Further, a dynamic friction coefficient of the surface layer is set to a value in the range of 0.3 to 0.7.

This is because even when the dynamic friction coefficient of the surface layer is a value within a range of 0.3 to 0.7, that is, the dynamic friction coefficient thereof is a value larger in comparison with that of a general electrophotographic photoconductor, the image forming apparatus as the invention enables to effectively prevent black spots from occurring while efficiently recovering the residual toner.

That is, as will be detailed in a later section, since the specific resistance of titanium oxide contained in the toner is stipulated in a predetermined range according to the image forming apparatus of the invention, the toner in the cleaning device can be effectively prevented from excessively charging.

Furthermore, when the specific resistance of titanium oxide is set to a value in the predetermined range, toner particles and additives remained on the surface of the latent image carrier can be efficiently recovered in the cleaning device, with the result that compositions of the toner particles and additives of the toner in the cleaning device can be readily controlled. As a consequence, in the cleaning device, an air gap can be effectively prevented from occurring between the toner and the latent image carrier, whereby the abrupt discharge can be prevented from occurring between the toner in the cleaning device and a surface of the latent image carrier.

Accordingly, even when the dynamic friction coefficient of the latent image carrier is within a predetermined range, it is possible to effectively suppress occurrence of a leakage current between the cleaning device and the latent image carrier and black spots in a formed image generated by the leakage current, while efficiently recovering the residual toner.

Since the dynamic friction coefficient of the surface layer can be made a value in the range of 0.3 to 0.7, the surface roughness of a surface layer can be readily controlled to a small value, and accordingly, the recovering efficiency of the residual toner can be further improved, as will be described in the next section.

Now, a method of measuring the dynamic friction coefficient of a latent image carrier will be described.

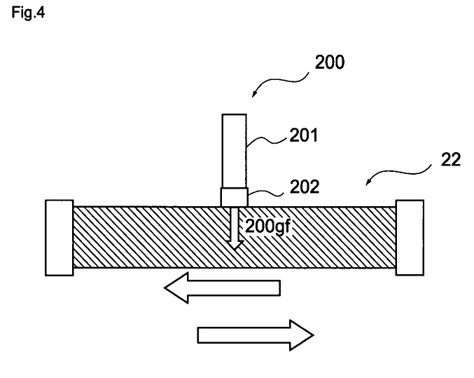

As shown in FIG. 4, knitted cloth 202 is fastened to a section of a block 201 having a section of 1 cm×1 cm square to obtain a friction material 200. Then, the section of the friction material 200 to which the knitted cloth 202 is fastened is vertically pressed against a surface of a latent image carrier 22 under 200 gf. Subsequently, a lateral force applied to the friction material 200 when the latent image carrier 22 is moved in a major axis direction is measured by use of, for example, a load cell (produced by Showa Sokki K. K.). Then, a value of obtained tensile load is divided by a value of vertical load (200 gf) to obtain the dynamic friction coefficient of the latent image carrier.

Further, mechanisms of generation of the leakage current between the cleaning device and the latent image carrier and black spots in a formed image caused by the leakage current and a mechanism of suppressing them will be detailed in a later section of titanium oxide.

Furthermore, a center line average surface roughness (Ra) of the surface layer measured based on JIS B0601 is preferably set to a value in the range of 0.010 to 0.040 μm.

This is because when the center line average surface roughness (Ra) of the surface layer measured based on JIS B0601 is set to a value within the range, the residual toner that slips the cleaning means can be reduced, thereby to improve the recovery efficiency.

That is, when the center line average surface roughness (Ra) becomes a value less than 0.010, such latent image carriers become difficult to stably produce, while on the other hand, when the center line average surface roughness (Ra) exceeds 0.040, the toner may not be effectively prevented from slipping in the cleaning.

Accordingly, the center line average surface roughness (Ra) of the surface layer measured based on JIS B0601 is preferably set to a value in the range of 0.015 to 0.030 μm and more preferably set to a value in the range of 0.015 to 0.020 μm.

Further, when the ten-point average roughness (Rz) of the surface layer measured based on JIS B0601 is set to a value of 200 nm or less, the above-mentioned advantages can be more effectively exerted.

A surface layer made of a-SiC may be formed by, similarly to the formation of a photoconductive layer, a plasma CVD method.

### (1)-5 Charge Injection Inhibiting Layer

Furthermore, as a charge injection inhibiting layer, one obtained by containing boron, nitrogen and oxygen as the dopant to a-Si can be used.

The charge injection inhibiting layer is a layer provided to prevent carriers (electrons) from being injected from the base body.

A film thickness of the charge injection inhibiting layer is preferably set to a value in the range of 2 to 7 μm and more preferably in the range of 3 to 6 μm.

Similarly to the formation of the photoconductive layer and surface layer, a plasma CVD method etc. can be preferably adopted as a method of forming the charge injection inhibiting layer.

### (2) Charging Device

As a kind of a charging device, a non-contact charging such as scorotron is preferably used, and as shown in FIG. 2, a charging roller 52 is more preferably used.

This is because use of the charging roller 52 enables to effectively suppress discharge products such as ozone that is readily generated in the non-contact charging process.

The charging roller 52 is preferably constituted to include a core metal, a conductive layer arranged outside thereof and a resistance layer arranged further outside thereof. In order to further clean the surface of the charging roller 52, a cleaning brush 53 that comes into rotation contact with a surface of the charging roller 52 a housing 51 is preferably further provided.

In order to maintain a contact force against the surface of the charging roller 52 always constant, though not shown in the drawing, a pressure control member can be preferably arranged between the cleaning brush 53 and the housing 51.

### (3) Developing Device

As shown in FIG. 2, in the developing device 60, a photo sensitive non-contact developing roller 61 is preferably arranged in the neighborhood of the photoconductor drum 22.

In such a constitution, when a bias having the polarity same as the discharging polarity of the photoconductor drum 22 is applied to the developing roller 61, a toner that is a developing agent is charged and flies to an electrostatic latent image on the surface of the photoconductor drum 22 to develop an electrostatic latent image.

The developing roller 61 may be a contact type with the photoconductor drum.

The primary transfer part 30 is provided with the primary transfer roller 31 that comes into contact with the photoconductor drum 22 through the intermediate transfer belt 8. The primary transfer roller 31 includes a core metal 32 and a conductive elastic layer 33 arranged outside thereof.

The conductive elastic layer 33 is made of polyurethane rubber having an electroconductive material such as carbon dispersed therein. Furthermore, the primary transfer roller 31 is supported through an arm 34 by a frame (not shown). The arm 34 is rotatable with an axis part 34a thereof as a center, and owing to the rotation operation, the primary transfer roller 31 moves up and down.

Accordingly, without having a driving device, the primary transfer roller 31, owing to contact with the intermediate transfer belt 8, can rotate as the intermediate transfer belt 8 rotates.

Furthermore, the primary transfer roller 31, in synchronization with the toner image formation on the surface of the photoconductor drum 22, moves from its downward position to come into contact with the intermediate transfer belt 8. According to this, the intermediate transfer belt 8 is pushed down to come into contact with the photoconductor drum 22. At that time, a transfer bias having negative polarity that is an opposite polarity to the photoconductor drum 22 and the toner is applied to the primary transfer roller 31. Thereby, the toner tries to move from the photoconductor drum 22 toward the primary transfer roller 31 and a toner image is contact transferred on the intermediate transfer belt 8. When the primary transfer roller 31 moves upward, the intermediate transfer belt 8 is separated from the photoconductor drum 22.

### (4) Charge Elimination Device

As shown in FIG. 2, the charge elimination device 70 is arranged along a rotation direction of the photoconductor drum 22 on a further downstream side of the primary transfer part 30.

The charge elimination device 70 is preferably constituted of a LED (light-emitting diode) 71 and a reflective plate 72. The LED 71 is arranged on a top surface of a housing 81 of the cleaning device 80.

In place of the LED 71, an EL (electroluminescence) light source or a fluorescent lamp can be preferably used. In that case, the reflective plate 72 is preferably arranged on the upper side of the LED 71 so as to cover the LED 71.

### (5) Cleaning Device

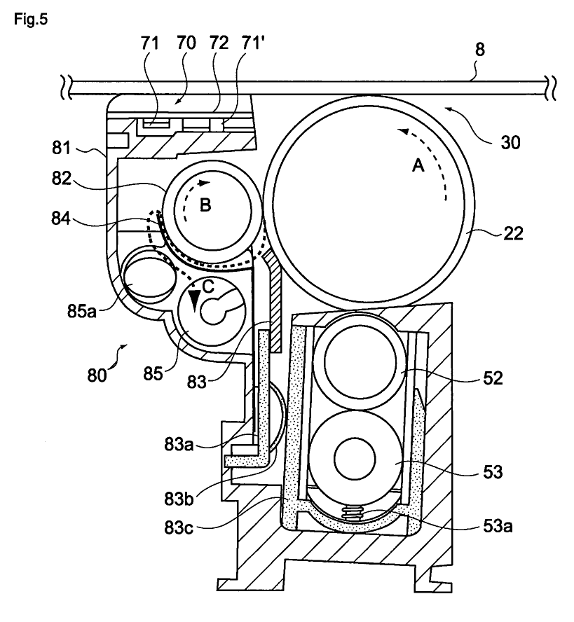

Next, the cleaning device 80 will be more detailed with reference to FIG. 5.

The cleaning device 80 is arranged on a further downstream side of the primary transfer part 30 and charge elimination device 70 along a rotation direction of the photoconductor drum 22 and constituted fundamentally of a cleaning blade 83, a rotation member 82, a toner receiving member 84 and the housing 81.

The cleaning device 80 further includes a sweep roll 85a l and a recovery roller 85.

### (5)-1 Cleaning Blade

The cleaning device 80 has the cleaning blade 83. This is because the cleaning blade can effectively scrape the residual toner off the surface of the photoconductor drum.

It is preferable that, as shown in FIG. 5, the cleaning blade 83 is arranged on a downstream side in a rotation direction of the photoconductor drum 22 of the rotation member 82 described below and on the lower side in an up and down direction relative to the rotation member 82 in the housing 81. The cleaning blade 83 is pressed, by an energizing means 83a and 83b, against the photoconductor drum 22 under a predetermined force.

Furthermore, the cleaning blade 83 is a planar member constituted of urethane rubber, silicone rubber, SBR, natural rubber, acrylic rubber or other resin materials, and has an axis line direction length substantially same as that of the photoconductor drum 22.

When a constituent material of the cleaning blade further contains a predetermined amount of carbon black or titanium oxide, the endurance thereof can be improved or the electric conductivity thereof can be imparted.

### (5)-2 Rotation Member

As shown in FIG. 5, the cleaning device 80 includes the rotation member 82 for cleaning the surface of the photoconductor drum 22.

The reason for this is that, when the cleaning device is provided with the rotation member 82, the surface of the photoconductor drum 22 can be effectively polished with, for example, titanium oxide as an additive in the toner. Accordingly, foreign matters attached on the surface of the photoconductor drum 22 can be effectively removed, and surface characteristics of the photoconductor drum 22 such as the friction coefficient and surface roughness can be maintained in an excellent state.

A resistance of an elastic layer formed on an outer periphery part of the rotation member 82 is preferably set to a value in the range of 1×10⁵ to 1×10¹⁰ Ω·cm.

Further, the rotation member 82 is preferably grounded.

This is because, when the specific resistance of an elastic body layer formed on an outer periphery part of a rotation member is set to a value in a predetermined range and the rotation member is grounded, the toner in the cleaning device can be prevented from excessively charging, and also, the residual toner on the latent image carrier can be efficiently recovered in the cleaning device.

That is because, when the specific resistance of the elastic body layer formed on the outer periphery part of the rotation member becomes a value less than 1×10⁵ Ω·cm, charges tend to move between the latent image carrier and the cleaning device through the rotation member, whereby the charging characteristics of the latent image carrier may be adversely affected, while on the other hand, when the specific resistance of the elastic body layer formed on the outer periphery part of the rotation member becomes a value exceeding 1×10Ω·cm, the conductivity of the rotation member may be deteriorated to make it difficult to exert the above-mentioned advantages.

Accordingly, the specific resistance of the elastic body layer formed on the outer periphery part of the rotation member is preferably set to a value in the range of 5×10⁵ to 5×10⁹ Ω·cm and more preferably set to a value in the range of 1×10⁶ to 1×10⁹ Ω·cm.

The specific resistance of the elastic body layer can be measured as follows, for example.

That is, a core metal having an elastic body layer formed thereon is cut into a chip of 20 mm×20 mm, followed by applying a mask to a surface of the elastic body layer of the chip so that an opening may be 0.5 cm². Subsequently, by use of an ion sputtering device, a gold electrode is sputter-deposited so as to have a film thickness of 40 nm.

A voltage of 500 V is applied between a gold electrode of a sandwich cell thus formed and the core metal to measure a current flowing at this time, and, from measurements, the specific resistance of the elastic body layer can be calculated.

Furthermore, a primary constituent material of the elastic body layer in the rotation member 82 is preferably at least one kind selected from the group consisting of ethylene-propylene-diene rubber, ethylene-propylene rubber, urethane rubber, silicone rubber, acrylic rubber and nitrile rubber.

This is because, when a primary constituent material in the elastic body layer is one of the rubber materials, it is possible not only to readily control the resistance of the elastic body layer in the rotation member within a predetermined range, but also to control the characteristics such as the hardness and the friction coefficient thereof to allow the toner in the cleaning device to be effectively carried on the surface of the rotation member.

Examples of a method of controlling the resistance of the elastic body layer in the rotation member include a method of adding, for example, carbon black, metal particles, alkali metal salt or perchlorate as a conductivity imparting agent to the primary constituent material.

It is preferred that the elastic body layer in the rotation member is made of a resin foam and an average cell diameter of the resin foam is set to a value in the range of 100 to 300 μm.

This is because, when the elastic body layer of the rotation member is formed of a resin foam having a predetermined average cell diameter, the toner in the cleaning device can be carried more effectively on the surface of the rotation member.

More specifically, that is because when an average cell diameter has a value less than 100 μm, foam cells tend to be clogged, and in some cases, the toner in the cleaning device can be efficiently carried with difficulty, while on the other hand, when an average cell diameter has a value exceeding 300 μm, the foam cells affect largely, and it is difficult in some cases to control the resistance and the hardness of the elastic body layer per se within an appropriate range.

Accordingly, the average cell diameter in the resin foam as the elastic body layer of the rotation member is set preferably in the range of 120 to 280 μm and more preferably in the range of 140 to 260 μm.

The Asker C hardness of the elastic body layer in the rotation member is preferably set to a value in the range of 30 to 65 degrees.

This is because, when the Asker C hardness of the elastic body layer of the rotation member is set to a value in the range, the toner in the cleaning device can be efficiently carried on the surface of the rotation member and a surface of a latent image carrier can be effectively polished.

That is, this is because when the Asker C hardness becomes a value less than 30 degrees, it is in some cases impossible to sufficiently exert a polishing effect owing to a polishing agent such as a titanium oxide carried by the rotation member, while on the other hand, when the Asker C hardness becomes a value exceeding 65 degrees, a nip width in a contact portion between the rotation member and the photoconductor drum cannot be sufficiently secured in some cases.

Accordingly, the Asker C hardness of the elastic body layer of the rotation member is preferably set to a value in the range of 40 to 60 degrees and more preferably to a value in the range of 45 to 55 degrees.

As a magnitude of the rotation member, a diameter thereof is preferably set to a value in the range of 10 to 30 mm. In order to make an effective polishing area of the rotation member 82 larger, it is preferred to have a length in an axis direction substantially same as that of the photoconductor drum 22.

As shown in FIG. 5, the rotation member 82 is preferably arranged, on an upper side in the housing 81, so as to be pressed against the photoconductor drum 22 under a predetermined force by use of an energizing means (not shown) provided at both ends of a shaft part.

Further, the rotation member 82 is preferably rotated by a driving means constituted of a motor or the like. In order to efficiently polish the surface of the photoconductor drum 22, the rotation member 82 is preferably rotated at a predetermined circumferential speed.

That is, it is preferred that the rotation member 82, as shown with an arrow mark B in FIG. 5, is rotated in a direction in which a surface of the rotation member 82 coming into contact with the photoconductor drum 22 moves in a direction same as that of the surface of the photoconductor drum 22 (arrow mark A in FIG. 5). The circumferential speed of the rotation member 82 is preferably set to a value in the range of 1 to 2 times a circumferential speed of the photoconductor drum 22.

### (5)-3 Toner Receiving Member

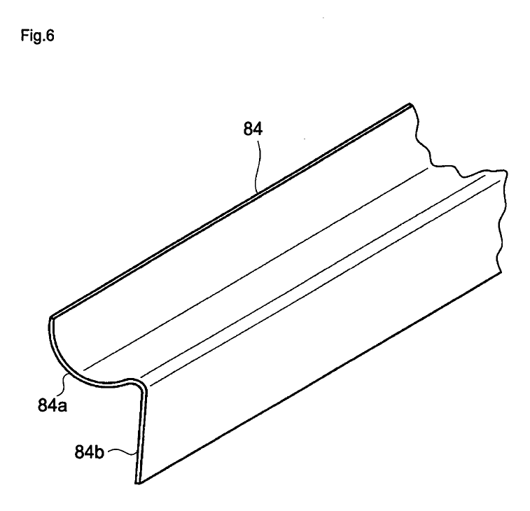

As shown in FIG. 5, the cleaning device 80 preferably has the toner receiving member 84 for storing the toner scraped off the photoconductor drum 22. As shown in FIG. 6, the toner receiving member 84 is preferably a gutter-like member along a circumferential surface of the rotation member 82.

This is because providing the toner receiving member 84 allows a titanium oxide or the like as an additive to be sufficiently carried on the rotation member 82 even when the downward transfer method is adopted as shown in FIG. 5.

This is also because, when the toner receiving member 84 is used, the toner can be smoothly conveyed through a sweep roll 85a to the toner recovery part 85 as shown with an arrow mark C in FIG. 5.

That is, the toner eliminated from the surface of the photoconduct or drum 22 by the rotation member 82 and the cleaning blade 83, when the toner receiving member 84 is not arranged, tends to move (fall) as it is below the rotation member 82 and the cleaning blade 83 under the action of gravity.

However, since the toner movement is interrupted by the toner receiving member 84, the toner is stored in a gap in the neighborhood of the circumferential surface of the rotation member 82 constituted by the toner receiving member 84. The toner, when stored in the gap, presses against the rotation member 82. As a result, the toner can be carried in the gap by the rotation member 82 from its downward position.

The toner that have not adhered to the rotation member 82 under the action of pressure as well can be carried at an end part on a downstream side of the toner receiving member 84 in a rotation direction of the rotation member 82 by the rotation member 82 under the action of the gravity.

Then, the rotation member 82 can polish the surface of the photoconductor drum 22 by use of the toner adhered on the surface of the rotation member 82 and containing the additive.

As mentioned above, while the additive can be effectively carried by the rotation member 82, the toner can be stably conveyed in a rotation direction thereof by making use of the rotation of the rotation member 82.

As shown in FIG. 2, an end part on a downstream side relative to a rotation direction of the rotation member 82 in the toner receiving member 84 is preferably located on the upper side than a contact part between the rotation member 82 and the photoconductor drum 22.

This is because this constitution enables to maintain a state where the toner receiving member 84 is appropriately filled with the toner.

Accordingly, the toner can be more efficiently carried by the rotation member 82 and the toner can be more smoothly conveyed to the toner recovery part 85.

Examples of the material of the toner receiving member 84 include stainless (SUS), aluminum (Al), copper (Cu), silver (Ag), a ceramic material, a conductive polycarbonate resin, an insulating polycarbonate resin, a conductive acrylic resin and an insulating acrylic resin.

The toner receiving member 84 preferably has a length substantially same as that in a shaft line direction of the rotation member 82. The toner receiving member 84 is preferably constituted in such a manner that, with a part at the end portion thereof on the downstream side in the rotation direction of the rotation member 82 left, the housing 81 is partitioned into a space where the rotation member 82 and the cleaning blade 83 are arranged and a space where the recovery roller 85 is arranged and the toner eliminated from the photoconductor drum 22 is stored in a gap in the neighborhood of the circumferential surface of the rotation member 82.

Further, in order to fill the gap, a sponge (not shown) is preferably packed between the toner receiving member 84 and the cleaning blade 83. At both end parts in a sheet width direction of the toner receiving member 84, a seal member such as an unillustrated sponge is arranged between the toner receiving member 84 and the housing 81 so as to prevent the toner stored in the toner receiving member 84 from leaking therefrom.

### (5)-4 Sweep Roller

The sweep roller 85a shown in FIG. 5 is a conveying member that, as shown with an arrow mark C, smoothly conveys the toner eliminated from the surface of the photoconductor drum 22 by the rotation member 82 and the cleaning blade 83 to the toner recovery part 85.

That is, the sweep roller 85a is a spherical rotation member that prevents the toner from remaining in the housing 81 and agitates the toner so as to be uniform.

The sweep roller 85a may be made of a resin, metal or ceramics. However, it can be configured similarly to known one.

### (5)-5 Recovery Roller

As shown in FIG. 5, the recovery roller 85 is preferably arranged on the lower side of the rotation member 82 in the housing 81.

This is because, by use of the recovery roller 85, a waste toner in the housing 81, which has been used for cleaning, can be efficiently ejected outside of the housing 81, that is, in a waste toner recovery vessel.

The recovery roller 85 extends from the inside of the housing 81 to the waste toner recovery vessel (not shown) arranged outside of the image forming part 20.

### 3. Toner

Available examples of the toner to be used include a magnetic or nonmagnetic one-component toner or a two-component toner in which a magnetic carrier and a nonmagnetic toner are mixed.

An average particle diameter of the magnetic toner is not particularly restricted, but it is preferably set to a value in the range of, for example, 5 to 12 μm.

This is because when an average particle diameter of the magnetic toner is a value less than 5 μm, the charging characteristics and the fluidity of the magnetic toner are deteriorated and, furthermore the isolation rate of the additive may become higher, while on the other hand, when the average particle diameter of the magnetic toner exceeds 12 μm, the fluidity of the toner may be deteriorated.

Accordingly, the average particle diameter of the magnetic toner is preferably set to a value in the range of 6 to 11 μm and more preferably set to a value in the range of 7 to 10 μm.

### (1) Binding Resin

Preferable examples of a binding resin used in the toner particle, although not particularly limited, include thermoplastic resins such as a styrene resin, an acrylic resin, a styrene-acryl copolymer, a polyethylene resin, a polypropylene resin, a vinyl chloride resin, a polyester resin, a polyamide resin, a polyurethane resin, a polyvinyl alcohol resin, a vinyl ether resin, a N-vinyl resin and a styrene-butadiene resin.

### (2) Wax

In order to obtain the fixability and offset property in the toner, waxes can be preferably added.

The kind of the waxes is not particularly restricted. Examples thereof include polyethylene wax, polypropylene wax, fluororesin wax, fisher-tropsh wax, paraffin wax, ester wax, montan wax and rice wax, which may be used singularly or in a combination of at least two kinds thereof.

### (3) Charge Control Agent

From viewpoints of remarkably improving the charge level and charge rise characteristics (index to charge to a constant charge level in a short time) and obtaining excellent characteristics in the endurance and the stability in the toner, a charge control agent can be preferably added.

The kind of the charge control agent is not particularly limited, and preferable examples thereof include the charge control agents showing the positive chargeability such as nigrosin, a quaternary ammonium chloride compound and a resin type charge control agent obtained by bonding an amine compound to a resin.

### (4) Magnetic Powder and Carrier

As a magnetic powder or carrier, known ones can be used.

Examples thereof include ferromagnetic metals or alloys such as ferrite, magnetite, iron, cobalt and nickel or compounds containing the ferromagnetic elements, or alloys containing no ferromagnetic element but showing the ferromagnetism after appropriate heat treatment.

### (5) Additive

### (5)-1 Titanium Oxide

In the toner, a titanium oxide can be preferably used as an additive.

This is because when the titanium oxide is used as an additive, the rotation member can more effectively polish the photoconductor drum. Accordingly, even when image formation is repeated, the surface of the photoconductor drum can be maintained in an excellent state.

Furthermore, an average particle diameter of a titanium oxide is preferably set to a value in the range of 0.01 to 0.50 μm.

This is because when the average particle diameter of a titanium oxide is less than 0.01 μm, uniform polishing is difficult to be effectively exerted and in some cases, the charging up is caused and the image deletion at high temperature and high moisture is caused to result in image defect, while on the other hand, when the average particle diameter of the titanium oxide exceeds 0.50 μm, the fluctuation in the charging amount in the toner becomes larger to, in some cases, result in lowering the image density and deteriorating the endurance.

Accordingly, the average particle diameter of the titanium oxide is set preferably to a value in the range of 0.02 to 0.4 μm and more preferably to a value in the range of 0.05 to 0.3 μm.

The average particle diameter of the titanium oxide can be measured by a combination of an electron microscope and an image analyzer. That is, with a magnification ratio appropriately set in the range of 30,000 to 100,000 times and by use of an electron microscope JSM-880 (manufactured by JOEL Ltd.,), a major axis and a minor axis are measured of 50 particles, followed by calculating averages thereof by use of an image analyzer.

The specific resistance of a titanium oxide is preferably set to a value in the range of 1×10⁰ to 1×10² Ω·cm.

This is because, when the specific resistance of the titanium oxide is set in the range, it is possible to, even when the dynamic friction coefficient of the latent image carrier is in a predetermined range, effectively suppress occurrence of the leakage current between the cleaning device and the latent image carrier and black spots in a formed image caused by the leakage current, while efficiently recovering the residual toner.

That is, when the dynamic friction coefficient of the latent image carrier is set in the predetermined range, the toner in the cleaning device can be effectively prevented from excessively charging.

According to a more specific description, the cleaning device in the image forming apparatus takes in some cases a constitution of storing the residual toner scraped off the surface of the photoreceptor drum. In such a case, there is a problem in that the toner is excessively charged since the toner stored in the cleaning device and the rotation roller and the photoreceptor drum are always in contact under friction. In particular, when the dynamic friction coefficient of the latent image carrier has a large value, such a problem was remarkable. Then, electric charges stored on the toner abruptly discharge to be a leakage current to flow toward the surface of the photoreceptor drum, with the result that there is a problem that the surface of the photoreceptor drum is damaged and black spots are generated in a formed image.

Such a problem is more likely to occur in the image forming apparatus that adopts a downward transfer method. That is, in the image forming apparatus that adopts a downward transfer method, the residual toner can be carried with difficulty on the rotation member from the structural problems thereof. Accordingly, the residual toner has to be stored in more proximity of the rotation member, so that the friction between the rotation member and the residual toner more tends to occur.

On the other hand, the image forming apparatus of the invention has such an advantage that by setting the specific resistance of the titanium oxide in the predetermined range, the toner in the cleaning device can effectively gradually release the stored electric charges through the titanium oxide of such a low specific resistance. As a result, the toner in the cleaning device can be more effectively prevented from excessively charging.

Accordingly, the leakage current from the toner in the cleaning device to the photoreceptor drum can be prevented from occurring, thereby to effectively prevent black spots generated by the leakage current from occurring.

Setting the specific resistance of a titanium oxide to a value in a predetermined range makes it possible to prevent an air gap from occurring between the toner in the cleaning device and the latent image carrier.

That is, as mentioned above, the cleaning device in the image forming apparatus in some cases takes a constitution of storing the toner in the cleaning device. In the cleaning device having such a constitution, there is a problem in that, in some cases, an air gap is generated between the toner stored in the cleaning device and the photoreceptor drum, and, owing to the air gap, the electric charges tend to be stored on the toner and abrupt discharge tends to occur. As a result, there is a problem that, owing to the abrupt discharge, the surface of the photoreceptor drum is damaged and black spots are generated on a formed image.

On the other hand, according to an image forming apparatus of the invention, a content of the titanium oxide in the toner in the cleaning device can be readily controlled since the specific resistance of the titanium oxide is set in a predetermined range. Accordingly, an air gap can be effectively prevented from occurring.

That is, since the charging properties of the titanium oxide can be varied by varying the specific resistance of the titanium oxide, a ratio of the titanium oxide transferred together with toner particles to a transfer body can be controlled in the transfer step. This allows control of the content of the titanium oxide in the toner recovered in the cleaning device.

Accordingly, the air gap can be filled with the titanium oxide, to thereby effectively prevent the electric charges from excessively storing on the toner in the cleaning device and the abrupt discharge from occurring.

As mentioned above, when the specific resistance of the titanium oxide is set to a value in a predetermined range, it is possible to effectively suppress occurrence of the leakage current between the cleaning device and the latent image carrier and black spots in a formed image caused by the leakage current, while efficiently recovering the residual toner.

When the specific resistance of the titanium oxide is a value less than 1×10⁰ Ω·cm, it is difficult, in some cases, to stably produce the titanium oxide having such low specific resistance. On the other hand, when the specific resistance of the titanium oxide is a value exceeding 1×10² Ω·cm, it is difficult, in some cases, to effectively suppress occurrence of the leakage current between the cleaning device and the latent image carrier and black spots in a formed image caused by the leakage current.

Accordingly, the specific resistance of the titanium oxide is set to a value preferably in the range of 1×10⁰ to 5×10¹ Ω·cm and more preferably in the range of 1×10⁰ to 1×10¹ Ω·cm.

A method of measuring the specific resistance of the titanium oxide will be described in a later example.

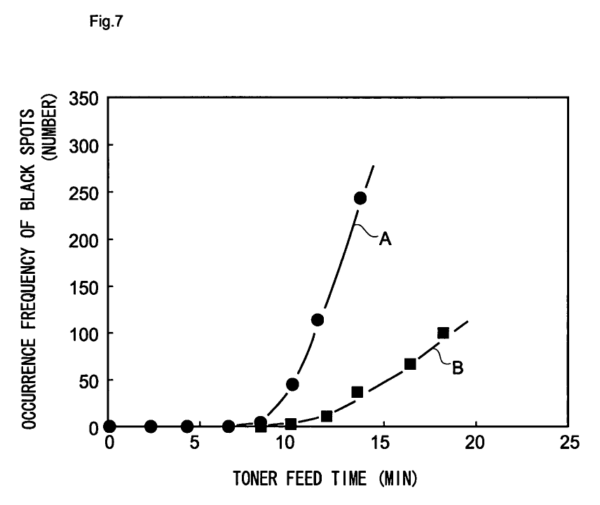

Next, the relationship between the specific resistance of a titanium oxide and the occurrence frequency of black spots will be specifically described with reference to FIG. 7.

FIG. 7 shows characteristic curves A and B with the abscissa indicating a toner feed time (min) and the ordinate indicating the occurrence frequency of black spots (number) when an accelerated test is carried out. As conditions for an accelerated test, the specific resistances of the titanium oxides as an additive in used toners are varied respectively as will be described below, and an amorphous-silicon photoconductor of which dynamic friction coefficient is 0.4 is used as a latent image carrier. Furthermore, with a primary transfer bias set off, developed toner all is recovered in the cleaning device. In this state, without passing an A4 paper, an original with 6%-density (corresponding to A4 size original) is printed at a speed of 23 sheets/min to perform an accelerated test.

Results of the accelerated test like this are separately confirmed to be correlated with the occurrence frequency of the black spots under actual image forming conditions.

Here, the characteristic curve A corresponds to a case where the titanium oxide having a medium specific resistance (8×10² Ω·cm) is added as the additive so as to be 1.5% by weight to a total amount of the toner. The characteristic curve B corresponds to a case where the titanium oxide having a low specific resistance (1×10² Ω·cm) is added as the additive so as to be 1.5% by weight to a total amount of the toner.

In the characteristic curve A, the black spots start occurring from around a time when the toner feed time (min) passes 8 min, and thereafter keep on abruptly increasing in the occurrence frequency thereof (number). Around a time when the toner feed time (min) passes 15 min, the occurrence frequency of the black spots (number) increases up to substantially 300.

On the other hand, in the characteristic curve B, the black spots start occurring from around a time when the toner feed time (min) passes 8 min. Thereafter, until a time when the toner feed time (min) passes 13 min, the occurrence frequency of the black spots remains there without substantially increasing. Subsequently, from around a time when the toner feed time (min) passes 13 min, the occurrence frequency of the black spots (number) start increasing at a substantially constant rate. However, the occurrence frequency of the black spots (number) is suppressed to substantially 120 even around a time when the toner feed time (min) passes 20 min.

Accordingly, it is found that, in the accelerated test, the occurrence frequency of the black spots can be effectively suppressed by setting the specific resistance of the titanium oxide as the additive to a value in the range of 1×10⁰ to 1×10² Ω·cm, even if the dynamic friction coefficient of the latent image carrier is a large value, 0.4.

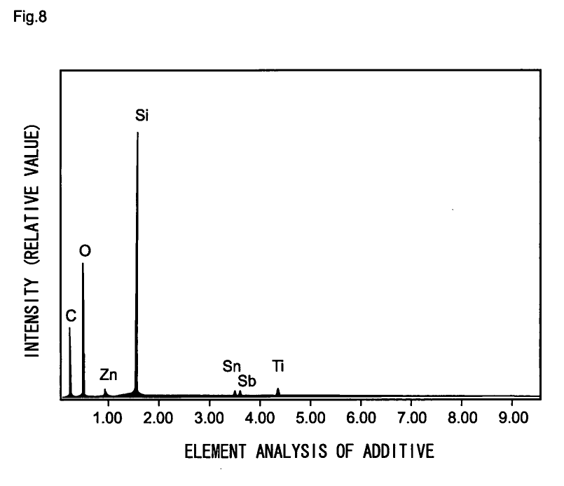

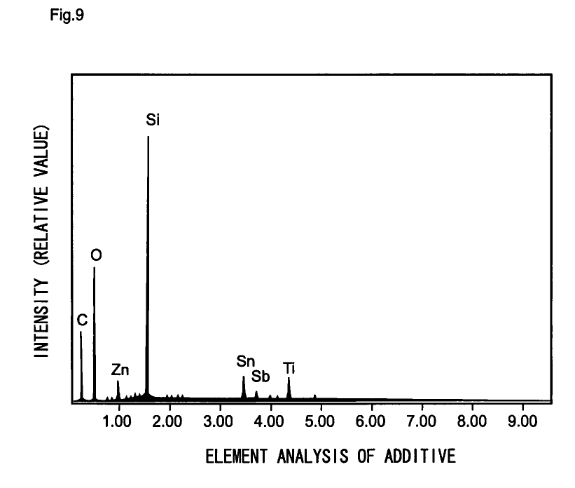

Then, with reference to FIGS. 8 and 9, an element analysis method that uses a fluorescence X-ray analyzer will be specifically described.

FIG. 8 shows results of the element analysis with a fluorescent X-ray analyzer in the toner in the cleaning device when the titanium oxide having a medium specific resistance is used as the additive in the toner.

FIG. 9 shows results of the element analysis with a fluorescent X-ray analyzer in the toner in the cleaning device when the titanium oxide having a low specific resistance is used as the additive in the toner.

It is understood from the two element analysis results, that, when the low specific resistance the titanium oxide is used as the additive in the toner, the content of the titanium oxide in the toner in the cleaning device can be increased as compared with the case when the medium specific resistance the titanium oxide is used.

Accordingly, it is found that the content of the titanium oxide in the toner in the cleaning device can be controlled by varying the specific resistance of the titanium oxide.

A measurement method that uses a fluorescent X-ray analyzer will be detailed in Example 1.

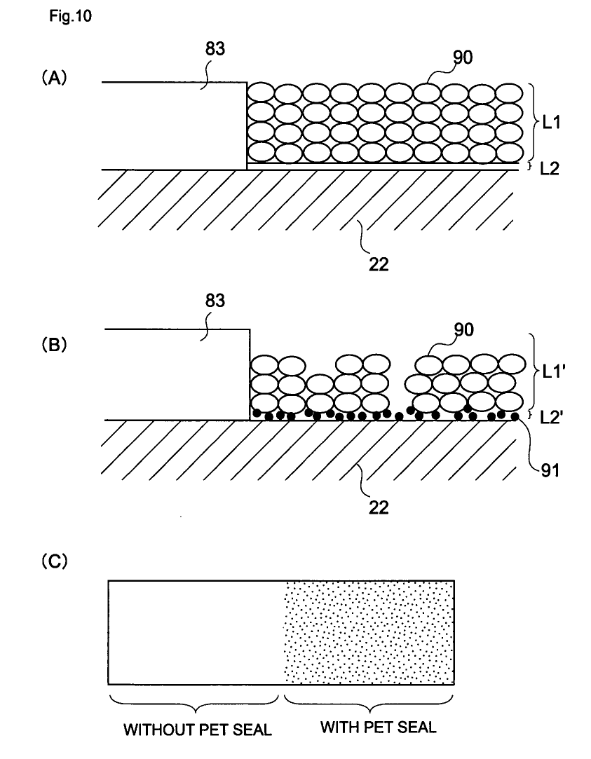

Subsequently, with reference to FIGS. 10A to 10C, description will be given to mechanisms of: occurrence of a leakage current from the toner inside of the cleaning device to the photoconductor drum; occurrence of the black spots due to the leakage current; and suppression thereof.

In the beginning, as shown in FIG. 10A, in a cleaning device when an image forming operation is repeated, a toner is packed and the toner flows as the photoconductor drum or the rotation member rotates, so that the friction is always generated between the toners each other and between the toner and the rotation member or the cleaning blade. As a result, when an image forming operation is repeated, the toner in the cleaning device is naturally charged.

On the other hand, the toner scraped off the surface of the electrophotographic photoconductor by the cleaning blade is assumed to form an air gap (L2) of substantially in the range of 0.1 to 10 μm between the toner and the photoconductor drum. The air gap (L2) swells up when new residual toners are successively transported between the toner layer (L1) formed on the photoconductor drum and the photoconductor drum to collide with the cleaning blade, whereby the toner layer (L1) is pushed upward in FIG. 10A.

Then, electric charges stored in the toner layer (L1) are insulated by the air gap (L2) to lose a chance of gradually discharging to the photoconductor drum. Consequently, the toner layer (L1) tends to be an excessively charged state.

As a result, when a charging amount in the toner layer (L1) exceeds a definite level, the discharge is generated at the air gap (L2).

Accordingly, the leakage current is caused from the toner in the cleaning device to the photoconductor drum in this manner.

Since the photoconductor drum is damaged owing to the leakage current, the damaged part is observed as a black spot in a formed image.

With reference to FIG. 10C, description will be given to the relationship between excessive charging in the toner in the cleaning device and occurrence of the black spots in a formed image.

That is, experimentally, a PET seal (PET: 50 μm, tacky layer: 50 μm) was adhered on a front half in a depth direction of the toner receiving member 84 arranged in the cleaning device 80 shown in FIG. 5. Consequently, of a gap formed between the toner receiving member 84 and the rotation member 82 arranged in the upper side thereof, the front half in the depth direction of the toner receiving member is completely clogged with the PET seal.

On the other hand, the gap of the rear half in the depth direction of the toner receiving member 84 is left as it is.

Next, a predetermined image is printed on 1000 sheets of A4-size paper with the image forming apparatus provided with the cleaning device in such a state.

At this time, since the toner cannot be ejected on a side where the PET seal is adhered in the cleaning device, the toner is packed in high density. In addition, since the rotation member 82 and the photoconductor drum 22 rotate, the toner of such a part is excessively charged owing to the friction.

On the other hand, the toner is ejected along a rotation direction of the rotation member 82 on a side where the PET seal is not adhered in the cleaning device 80, and thus, the toner is not excessively charged in comparison with the side where the PET seal is adhered.

In FIG. 10C, a white-paper image formed after the image formation is partially shown. As understood from the FIG. 10C, the black spots are remarkably observed in an image formed on a part of the photoconductor drum located on the side where the PET seal is adhered (front half in a depth direction).

On the other hand, in an image formed on a part of the photoconductor drum located on the side where the PET seal is not adhered (rear half in a depth direction), the black spot is not at all observed.

From the results, it is understood that a close relationship exists between the excessive charging of the toner in the cleaning device and the occurrence of the black spots in a formed image.

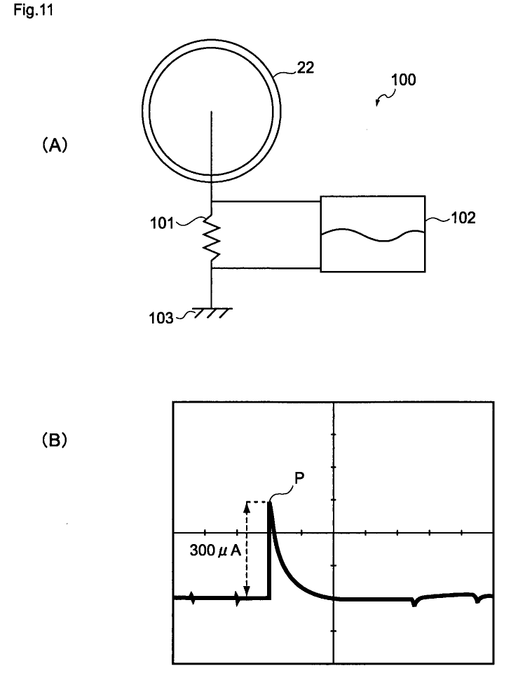

Further, with reference to FIGS. 11A and 11B, description will be given to the relationship between the excessive charging of the toner in the cleaning device and the leakage current between the cleaning device and the photoconductor drum. That is, FIG. 11A is a diagram showing a detection system 100 for detecting the leakage current between the cleaning device and the photoconductor drum, and FIG. 11B is measurement chart of the current.

When a leakage current is measured, the toner receiving member 84 of the cleaning device 80 shown in FIG. 5 was filled with a toner in advance and a new a-Si photoconductor drum 22 was mounted on the image forming apparatus 1.

Next, with a resistance (12 kΩ) 101 connected to a drum earth, voltage variations (current variations) at both ends of the resistance 101 were measured with an oscilloscope 102.

As other measurement conditions, a drum shaft and a motor are electrically insulated with a PET film, and the rotation member and the toner receiving member are grounded. Furthermore, a charging step, a transfer step and a developing step are not carried out and omitted.

The result shows that, as shown in FIG. 11B, a leakage current that has a waveform having a peak (P) and a value of the peak (P) of substantially 300 μA instantaneously flows. Furthermore, it has been separately confirmed that, when the leakage current like this flows, the surface of the a-Si photoconductor is damaged and a black spot is generated corresponding to that part.

From the results, it has been found that electric charges excessively stored in the toner in the cleaning device causes the leakage current between the cleaning device and the photoconductor drum and the leakage current damages the surface of the photoconductor drum, leading to occurrence of the black spots.

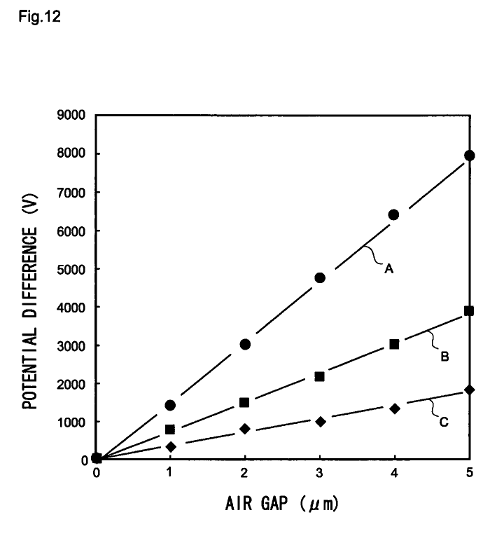

Next, with reference to FIG. 12, specific description will be given to the relationship among a magnitude of the air gap, a potential difference between the toner layer and the photoconductor drum and a toner layer thickness.

FIG. 12 shows characteristic curves A to C in which the abscissa indicates a magnitude (μm) of the air gap and the ordinate indicates a potential difference (V) between the toner layer and the photoconductor drum. The characteristic curves A to C correspond to cases where a toner charge amount in the toner layer is set to 4 μC/g and thicknesses of the respective toner layers are set to 1 mm, 2.3 mm and 5 mm.

As obvious from the characteristic curves A to C as well, the potential difference (V) between the toner layer and the photoconductor drum, the magnitude (μm) of the air gap, and the toner layer thickness (mm) are substantially proportional.

It is also found that the potential difference between the toner layer and the photoconductor drum when, for example, in the characteristic curve B, a magnitude of the air gap is 3 μm, is a value of 2000 V or more. This shows that the potential difference between the toner layer and the photoconductor drum under the conditions where the magnitude of the air gap is 3 μm and the toner layer thickness is 2.3 mm becomes a value of 2000 V or more.

The magnitude of the air gap and thickness of the toner layer are assumed to be average conditions. Accordingly, it shows that, even under actual image forming conditions, the potential difference between the toner layer and the photoconductor drum can be a value of 2000 V or more. It is understood that, under the conditions, the discharge is caused and very large current leaks to the photoconductor drum, with the result that the surface of the photoconductor drum is damaged.

On the other hand, when a rotation member having an elastic body layer with a predetermined resistance is used, the neighborhood of the cleaning blade is confirmed to be a state shown in FIG. 10B from a micrograph.

That is, it is found that not only a thickness of the toner layer (L1′) is relatively thin, but also a gap is formed in the deposited layers. Above all, it is found that an additive such as a titanium oxide is present between the toner layer (L1′) and the photoconductor drum to effectively prevent an air gap from being generated. Such an effect is caused because the toner remaining on the surface of the photoconductor drum, in particular, the additive such as a titanium oxide can be effectively recovered in the cleaning device.

Accordingly, when the specific resistance in the additive such as the titanium oxide is controlled in an appropriate range, electric charges accumulated in the toner layer (L1′) can be gradually released to the photoconductor drum, with the result that the photoconductor drum can be effectively prevented from being damaged by the leakage current.

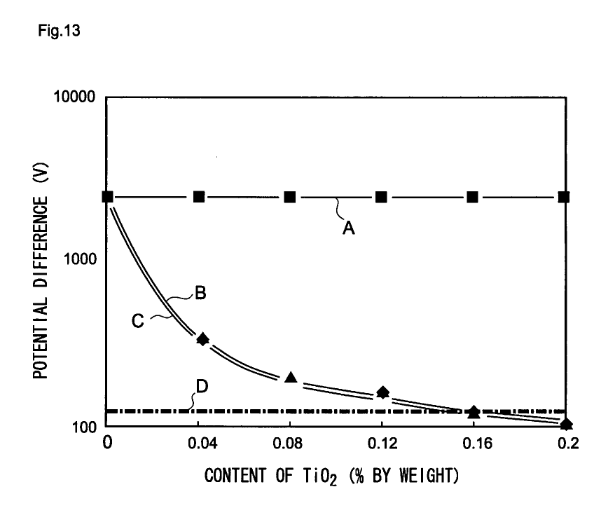

Then, with reference to FIG. 13, description will be given to the relationship between the titanium oxide as an additive and the potential difference between the toner layer and the photoconductor drum.

In FIG. 13, the abscissa indicates the content (% by weight) of the titanium oxide and the ordinate indicates the potential difference (V) between the toner layer and the photoconductor drum. Characteristic curves A to C corresponding thereto are shown.

The characteristic curves A to Care characteristic curves where, a toner charging amount in the toner layer is set to 4 μC/g, a toner layer thickness is set to 2.3 mm, a magnitude of the air gap is set to 3 μm and the titanium oxide contents are virtually set respectively as follows.
Characteristic curve A: A content (% by weight) when the titanium oxide is contained only in the toner layer.
Characteristic curve B: A content (% by weight) when the titanium oxide is contained only in the air gap.
Characteristic curve C: A content (% by weight) when the titanium oxide is contained in both of the toner layer and air gap.

A characteristic curve D shows a potential difference where the spark discharge is caused between the toner layer and the photoconductor drum and, in a region above the characteristic curve D, the spark discharge is caused and thereby the black spots may be generated.

As obvious from the characteristic curve A, when only the content (% by weight) of the titanium oxide in the toner layer is increased, the potential difference (V) between the toner layer and the photoconductor drum keeps on maintaining substantially 2000 V and hardly varies.

As obvious from the characteristic curve B, on the other hand, only the content (% by weight) of the titanium oxide in the air gap is increased, the potential difference (V) between the toner layer and the photoconductor drum decreases in association with the increase. More specifically, it is found that, when the content (% by weight) of the titanium oxide in the air gap is increased to 0.04% by weight, the potential difference (V) rapidly decreases from substantially 2000 V to substantially 550 V. It is also found that, when the content (% by weight) of the titanium oxide in the air gap is further increased, the potential difference (V) keeps on decreasing while weakening the extent of decrease.

As obvious from characteristic curves C and B that are depicted substantially overlapped, it is found that, when the content (% by weight) of the titanium oxide in both of the toner layer and the air gap is varied, only the content (% by weight) of the titanium oxide in the air gap affects on the potential difference (V).

Accordingly, it is clear from the characteristic curves A to C shown in FIG. 13 that, when the content (% by weight) of the titanium oxide in the air gap is increased, the potential difference (V) between the toner layer and the photoconductor drum can be decreased.

An additional amount of the titanium oxide is preferably set to a value in the range of 0.1 to 5 parts by weight with respect to 100 parts by weight of the toner particles.

This is because, when a content of the titanium oxide is set to a value in the range of 0.1 to 5 parts by weight, a relational expression (1) described below can be readily satisfied while a polishing effect to a photoreceptor drum can be effectively exerted.

That is, this is because, when the additional amount is a value less than 0.1 parts by weight, the content of the titanium oxide in the toner in the cleaning device becomes difficult to increase, whereby it may be difficult to control the content of the titanium oxide in the toner in the cleaning device to a preferable state that satisfies the relational expression (1) described below and to exert effectively the polishing effect, and in some cases, image quality under high temperature and high moisture conditions is remarkably deteriorated; while on the other hand, when the additional amount exceeds 5 parts by weight, the fluidity of the toner may be deteriorated.

Accordingly, an additional amount of the titanium oxide is preferably set to a value in the range of 1 to 2 parts by weight and more preferably in the range of 1.2 to 1.6 parts by weight, with respect to 100 parts by weight of the toner particles.

### (5)-2 Silica Particles

As an additive to toner particles, silica particles (hereinafter, in some cases, referred to as agglomerated silica particles) are preferably added as an additive.

The silica particles preferably have a particle size distribution where a ratio of particles having a particle diameter of 5 μm or less is a value equal to 15% by weight or less to a total amount and a ratio of particles having a particle diameter of 50 μm or more is a value of 3% by weight or less.

This is because when a ratio of silica particles having a particle diameter of 5 μm or less exceeds 15% by weight, the silica particles tend to adhere to photoconductor particles to reflocculate and gather around silica particles relatively large in the particle diameter to be likely to generate the layer irregularity; while on the other hand, when a ratio of silica particles having a particle diameter of 50 μm or more exceeds 3% by weight, these collect silica particles relatively small in the particle diameter in the surrounding thereof to form largely flocculated silica particles to be likely to generate the layer irregularity as well.

Accordingly, in a more preferable particle size distribution of the silica particles, a ratio of particles having a particle diameter of 5 μm or less is set, relative to a total amount, to a value of 10% by weight or less and a ratio of particles having a particle diameter of 50 μm or more is set to a value of 2% by weight or less.

The particle size distribution of the silica particles can be measured by use of a laser diffraction particle size analyzer LA-500 (trade name, manufactured by Horiba, Ltd.).

An additional amount of silica is preferably set to a value in the range of 0.5 to 15.0 parts by weight with respect to 100 parts by weight of the toner particles.

This is because when an additional amount of the additive is less than 0.5 parts by weight, an improvement effect in the fluidity of the toner maybe sufficiently exerted with difficulty, while on the other hand, when the additional amount of the additive exceeds 15.0 parts by weight, a relational expression (2) described below may be satisfied with difficulty since an additional amount of silica in the toner in the cleaning device becomes excessively large.

Accordingly, the additional amount of the additive is set preferably to a value in the range of 0.7 to 10.0 parts by weight and more preferably to a value in the range of 0.9 to 5.0 parts by weight, with respect to 100 parts by weight of the toner particles.

### (6) Toner Characteristics

### (6)-1 Fluorescent X-ray Intensity Ratio 1

In the image forming apparatus as the invention, when it is assume that a fluorescent X-ray intensity of the titanium oxide in a toner before use is X1 and a fluorescent X-ray intensity of the titanium oxide in the toner in the cleaning device is X2, the X1 and the X2 preferably satisfy a relational expression (1) below.

X2/X1≧1.4 (1)

This is because, when a fluorescent X-ray intensity ratio of the titanium oxides in the toner before use and the toner in the cleaning device is set to a value in the range, the toner in the cleaning device can be prevented from excessively charging.

Accordingly, this is because the leakage current from the toner in the cleaning device to the photoconductor drum can be prevented from occurring, whereby the black spots generated owing to the leakage current can be effectively prevented from occurring.

That is, this is because when the value of X2/X1 is a value less than 1.4, the content of the titanium oxide in the toner in the cleaning device becomes insufficient, and consequently an air gap described below is generated and the toner is excessively charged, so that in some cases, the leakage current tends to be generated.

On the other hand, when the content of the titanium oxide in the toner in the cleaning device becomes excessively large, the fluidity of the toner may be deteriorated or, owing to excessive polishing effect, the charging characteristics in the photoconductor drum may be locally much raised.

Accordingly, the X1 and the X2 more preferably satisfy a relational expression (1′) below and more preferably further satisfy a relational expression (1″) below.

1.5≦X2/X1≦5 (1′)

1.8≦X2/X1≦4 (1″)

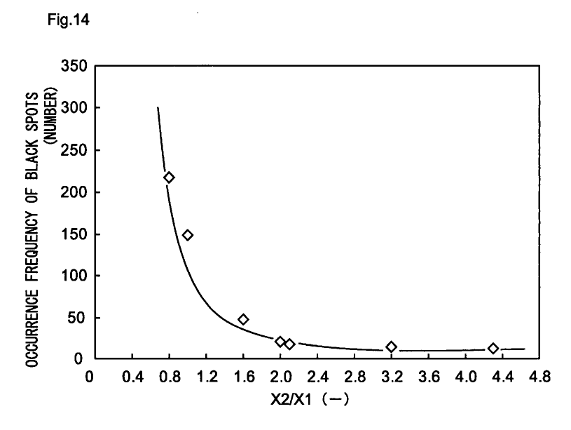

Next, a relationship between the ratio, X2/X1, and the occurrence frequency of the black spots will be specifically described with reference to FIG. 14.

In FIG. 14, the abscissa indicates a ratio of X2/X1 (−) and the ordinate indicates the occurrence frequency of the black spots (number) when an accelerated test is carried out. The conditions of the accelerated test are same as mentioned above.

Here, it is understood that, as the characteristic curve of FIG. 14 shows, the smaller the ratio of X2/X1 is, the more abundant the occurrence frequency of the black spots (number) in the accelerated test becomes. For example, when the ratio of X2/X1 is 0.8, the occurrence frequency of the black spots exceeds 200.

On the other hand, as the ratio of X2/X1 becomes larger, the occurrence frequency of the black spots (number) in the accelerated test decreases. Specifically, when the ratio of X2/X1 becomes 1.4 or more, the occurrence frequency of the black spots (number) in the accelerated test remarkably decreases.

Furthermore, as the ratio of X2/X1 becomes further larger, the occurrence frequency of the black spots (number) in the accelerated test further decreases, and the black spots are not substantially generated from around a ratio of X2/X1 that exceeds 2 in the accelerated test.

Accordingly, not only in the accelerated test but also in an actual image forming apparatus, it is assumed that, when the ratio of X2/X1 is set to a value equal to a predetermined value or more, the occurrence frequency of the black spots can be effectively suppressed.

### (6)-2 Fluorescent X-ray Intensity Ratio 2

When, in addition to the titanium oxide, silica is further contained as the additive and a fluorescent X-ray intensity of silica in the cleaning device is expressed with X3, the X2 (fluorescent X-ray intensity of the titanium oxide in the toner in the cleaning device) and X3 preferably satisfy a relational expression (2) below.

X3/X2≦20 (2)

This is because, when silica is used as an additive, the fluidity of the toner can be improved, with the result that, with a balance between the toner fluidity and the polishing properties excellently maintaining, the toner in the cleaning device can be effectively prevented from excessively charging.

That is, this is because when a value of (x3/X2) becomes a value exceeding 20, the titanium oxides in an air gap are prevented from coming into contact with each other owing to an excessive amount of silica, whereby electric charges accumulated in the toner become difficult to be efficiently gradually released to a photoconductor drum.

On the other hand, when the content of silica in the toner in the cleaning device becomes excessively slight, the fluidity of the toner becomes difficult to improve in some cases.

Accordingly, the X2 and the X3 are more preferred to satisfy a relational expression (2′) below and still more preferred to satisfy a relational expression (2″) below.

3≦X3/X2≦15 (2′)

5≦X3/X2≦10 (2″)

### EXAMPLES

Hereinbelow, the invention will be further detailed with reference to examples. It goes without saying that the following description exemplifies the invention and, without particular reasons, a range of the invention is not restricted by the following description.

### 1. Production of Amorphous-Silicon Photoconductor

### (1) Production of Amorphous-Silicon Photoconductor A

As a conductive base, a drawn pipe made of an aluminum alloy and having an outer diameter of 30 mm, a length of 340 mm and a thickness of 1.5 mm was prepared. Next, a surface of the conductive base was ground.

Subsequently, the obtained conductive base was set to a glow discharge decomposition device, and a rectangular wave pulse voltage of 33 KHz was applied to the case. Under layering conditions shown in Table 1, a charge injection inhibiting layer, a photoconductive layer and a surface layer were sequentially laminated to prepare an amorphous-silicon photoconductor A.

Furthermore, an on/off duty ratio of the rectangular wave pulse voltage was set at 70%:30% and a value in Table 1 shows a value at an ON time.

In Table 1, symbol “*” expresses a flow rate ratio of a SiH₄ gas (same in what follows)

### (2) Production of Amorphous-Silicon Photoconductor B

When an amorphous-silicon photoconductor B was produced, a photosensitive layer was layered in the same manner as in the amorphous-silicon photoconductor A except that a surface of a conductive base was ground coarser.

### (3) Amorphous-Silicon Photoconductor C

When an amorphous-silicon photoconductor C was produced, the above-mentioned amorphous-silicon photoconductor B was mounted on KM-C3232 (trade name, produced by Kyocera-Mita Co., Ltd.), and continuous charging (AC bias: kVpp, DC bias: 350 V) was carried out for 15 min without using toner to vary the surface characteristics thereof. The continuous charging is a very severe charging condition for the amorphous-silicon photoconductor because the toner was not used.

TABLE 1

| | | Charge | | Surface layer | |
|---|---|---|---|---|---|
| | | injection | | | Free |
| | | inhibiting | Photoconductive | Interface | surface |
| Kind of layer | | layer | layer | side | side |
| Gas | SiH₄(sccm) | 170 | 340 | 30 | 30 |
| flow | B₂H₆* | 0.12% | 0.3 ppm | 100 | 100 |
| rate | NO* | 10% | — | — | — |
| | CH₄(sccm) | — | — | 120 | 600 |

| | | | | |
|---|---|---|---|---|
| Gas | 60 | 60 | 80 | 80 |
| pressure(Pa) | | | | |
| Base | 300 | 320 | 300 | 300 |
| temperature(° C.) | | | | |
| Pulse | −950 | −1050 | −400 | −400 |
| voltage(V) | | | | |
| Film | 5 | 14 | 0.3 | 0.5 |
| thickness(μm) | | | | |

### 2. Surface Characteristics

### (1) Dynamic Friction Coefficient

A dynamic friction coefficient of each of the obtained amorphous-silicon photoconductors was measured.

That is, knitted cloth (white knitted cloth waste, produced by Nihon Waste K. K.) was fastened to a section of a block having a section of 1 cm×1 cm square to obtain a friction material. Then, a section of the friction material to which the knitted cloth was fastened was vertically pressed against a surface of an amorphous-silicon photoconductor under 200 gf. Subsequently, a lateral force applied to the friction material when the amorphous-silicon photoconductor was moved in a major axis direction thereof was measured by use of, for example, a load cell (produced by Showa Sokki K. K.) to calculate the dynamic friction coefficient. The obtained results are shown in Table 2.

### (2) Center Line Average Surface Roughness (Ra)

A center line average surface roughness (Ra) of a surface layer of each of the obtained amorphous-silicon photoconductors was measured based on JIS B0601. The obtained results are shown in Table 2.

### Example 1

### 1. Preparation of Toner

### (1) Preparation of Toner Particles

First, a plurality of polyester resins were used as a binder resin and a magnetic powder and the like were mixed therewith, followed by melting and kneading.

That is, by use of a Henshel mixer, mixed were 100 parts by weight of a polyester resin (alcohol component: bisphenol A propionoxide adduct, acid component: terephthalic acid, Tg: 60° C., softening point: 150° C., acid value: 7.0, gel fraction: 30%), 3 parts by weight of CCA (trade name: Bontron No. 1, manufactured by Orient Chemical Industries, Ltd. ) as a charge control agent, 3 parts by weight of a charge control resin (quaternary ammonium salt-added styrene-acryl copolymer, trade name: FCA196, manufactured by Fujikura Kasei K. K) and 3 parts by weight of ester wax (trade name: WEP•5, manufactured by Nippon Oil and Fats Co., Ltd.) as a wax component.

Next, a bi-axial extruder (cylinder setting temperature: 100° C.) was used to further knead the mixture, followed by coarsely pulverizing it by use of a feather mill. Thereafter, the mixture was finely pulverized by a turbo-mill, followed by being classified by an air-flow type classifier, to obtain toner particles having an average particle diameter of 8.0 μm.

### (2) Addition of Additive

To 100 parts by weight of the obtained toner particles, mixed were 0.8 parts by weight of silica particles (trade name: RA200HS, manufactured by Nippon Aerosil Co., Ltd.) and 1.0 parts by weight of the titanium oxide (trade name: EC300, manufactured by TITAN KOGYO KABUSHIKI KAISHA) by a Henshel mixer, to obtain a toner.

A specific resistance of the titanium oxide as the external additive was measured.

That is, the specific resistance of the titanium oxide was measured with a Ultra High Resistance Meter (trade name: R8340A, produced by Advantest Corp.) as follows. 10 g of the titanium oxide fine particles was pressurized under pressure of 58.8 MPa to mold a cylinder having a diameter of 25 mm. Then, while applying a load of 1 kg in an axis direction of the cylinder, a voltage of 10 V was applied between both ends of the cylinder to measure. The obtained results are shown in Table 2.

### 2. Fluorescent X-Ray Measurement

### (1) Fluorescent X-Ray Intensity of Titanium Oxide in Toner Before Use

A fluorescent X-ray intensity (X1) of the titanium oxide of the obtained toner was measured by a fluorescent X-ray analyzer.

That is, 5 g of the toner particles was molded into a disc-like pellet (diameter: 40 mm, thickness: 5 mm) by pressurizing at 20 MPa for 3 sec by a sample press-molding machine (trade name: BRE-32, manufactured by Maekawa testing Machine Co., Ltd.), followed by measuring fluorescent X-ray peak intensity (kcps) pertaining to Ti contained in the toner by use of a fluorescent X-ray analyzer (trade name: RIX200, manufactured by Rigaku Corp.) (voltage: 50 kV, current: 30 mA, X-ray tube: Rh).

### (2) Fluorescent X-ray Intensity of Titanium Oxide in Toner in Cleaning Device

Further, a fluorescent X-ray intensity (X2) of the titanium oxide in the toner in the cleaning device was measured by a fluorescent X-ray analyzer.

That is, by use of the obtained toner, KM-C3232 (trade name, manufactured by Kyocera-Mita Co., Ltd.) having a rotation member provided with the amorphous-silicon photoconductor A and A4-size papers, a predetermined image was continuously formed on 1000 sheets under the following conditions, followed by taking out the toner from the cleaning device of the image forming apparatus. A fluorescent X-ray intensity was measured by a fluorescent X-ray analyzer in the same manner as in the measurement of the fluorescent X-ray intensity in the toner before use, except that the toner was used.

When the fluorescent X-ray intensity is measured, the image forming conditions are set as follows.

### (Image Forming Conditions)

Environment: 23° C. and 50% RH
Original: original having 6%-density to the respective colors
Photoconductor: amorphous-silicon photoconductor A
Drum circumferential speed: 150 mm/s
Printing speed: 32 sheets/min
Surface potential: 270 V

### (Charging Conditions)

AC bias: 1.2 kVpp
DC bias: 350 V

### (Cleaning Blade Conditions)

Blade hardness: 70° (JIS-A standard)
Material: urethane
Thickness: 2.2 mm
Projection length: 11 mm
Linear pressure: 22 g/cm
Press-contact angle: 25°

### (Slide Friction Roller)

Outer diameter: 15 mm
Thickness: 1.5 mm
Material: EPDM
Specific resistance: 1.3×10⁶ Ω·cm
Circumferential speed difference with a drum: 1.2 times

### (Rotation in a Trail Direction Relative to a Drum)

Asker C hardness: 35°

### (3) Fluorescent X-ray Intensity of Silica in Toner in Cleaning Device

Furthermore, a fluorescent X-ray intensity (X3) of silica in the toner in the cleaning device was measured by a fluorescent X-ray analyzer.

That is, measurement was performed with a fluorescent X-ray analyzer in the same manner as in the measurement of the fluorescent X-ray intensity of the titanium oxide in the toner in the cleaning device.

### (4) Fluorescent X-ray Intensity Ratio

Values of ratios (X2/X1) and (X3/X2) as the fluorescent X-ray intensity ratio, respectively, were calculated from the obtained X1 to X3. The obtained results are shown in Table 2.

### 3. Evaluation

With the obtained image forming apparatus, an image was formed and the occurrence frequency of the black spots was evaluated.

That is, after a predetermined image is continuously printed on 1,000 sheets with A4-size sheets under the foregoing conditions, a white-paper image (A4-size) was formed, and the occurrence frequency of the black spots in the white-paper image was measured to evaluate under criteria below. The obtained results are shown in Table 2.
Very good: the occurrence frequency of the black spots is a value less than 20 points/A4-size paper
Good: the occurrence frequency of the black spots is a value in the range of 20 to 60 points/A4-size paper
Fair: the occurrence frequency of the black spots is a value in the range of 60 to 100 points/A4-size paper
Bad: the occurrence frequency of the black spots is a value of 100 points/A4-size paper or more

### Example 2

In Example 2, a toner was prepared and evaluated in the same manner as in Example 1 except that an additional amount of the titanium oxide was changed to 0.8 parts by weight with respect to 100 parts by weight of toner particles. The obtained results are shown in Table 2.

### Example 3

In Example 3, a toner was prepared and evaluated in the same manner as in Example 1 except that an additional amount of silica was changed to 1.5 parts by weight with respect to 100 parts by weight of toner particles. The obtained results are shown in Table 2.

### Example 4

In Example 4, a toner was prepared and evaluated in the same manner as in Example 1 except that a specific resistance of the titanium oxide was set to 10 Ω·cm. The obtained results are shown in Table 2.

### Example 5

In Example 5, a toner was prepared and evaluated in the same manner as in Example 1 except that a specific resistance of the titanium oxide was set to 10 106 ·cm and an additional amount of the titanium oxide was changed to 1.2 parts by weight with respect to 100 parts by weight of toner particles. The obtained results are shown in Table 2.

### Example 6

In Example 6, a toner was prepared and evaluated in the same manner as in Example 1 except that an amorphous-silicon photoconductor B was used as an amorphous-silicon photoconductor. The obtained results are shown in Table 2.

### Example 7

In Example 7, a toner was prepared and evaluated in the same manner as in Example 2 except that an amorphous-silicon photoconductor B was used as an amorphous-silicon photoconductor. The obtained results are shown in Table 2.

### Example 8

In Example 8, a toner was prepared and evaluated in the same manner as in Example 3 except that an amorphous-silicon photoconductor B was used as an amorphous-silicon photoconductor. The obtained results are shown in Table 2.

### Example 9

In Example 9, a toner was prepared and evaluated in the same manner as in Example 4 except that an amorphous-silicon photoconductor B was used as an amorphous-silicon photoconductor. The obtained results are shown in Table 2.

### Example 10

In Example 10, a toner was prepared and evaluated in the same manner as in Example 5 except that an amorphous-silicon photoconductor B was used as an amorphous-silicon photoconductor. The obtained results are shown in Table 2.

### Comparative Example 1

In Comparative Example 1, a toner was prepared and evaluated in the same manner as in Example 1 except that an amorphous-silicon photoconductor C was used as an amorphous-silicon photoconductor. The obtained results are shown in Table 2.

### Comparative Example 2

In Comparative Example 2, a toner was prepared and evaluated in the same manner as in Example 4 except that an amorphous-silicon photoconductor C was used as an amorphous-silicon photoconductor. The obtained results are shown in Table 2.

### Comparative Example 3

In Comparative Example 3, a toner was prepared and evaluated in the same manner as in Example 1 except that a specific resistance of the titanium oxide was set to 4×10⁴ Ω·cm. The obtained results are shown in Table 2.

TABLE 2

| | | | | | | | | | Evaluation | |
|---|---|---|---|---|---|---|---|---|---|---|
| | | | | | | | | | of Occurrence | |
| | Amorphous-silicon photoconductor | | | Toner Characteristics | | | | | Frequency of | |
| | | Surface Layer | | | | Content | | | Black Spots | |
| | | | Center | | | of | Ratio of | | Occurrence | |
| | | Dynamic | line | Titanium Oxide | | silica | fluorescent | | frequency of | |
| | | friction | average | Content | Specific | (parts | X-ray | | black spots | |
| | | coefficient | roughness | (parts by | resistance | by | intensity | | (number/A4 | |
| | Photoconductor | (—) | (μm) | weight) | (Ω · cm) | weight) | X2/X1 | X3/X2 | paper) | Evaluation |
| Example 1 | A | 0.4 | 0.015 | 1.0 | 30 | 0.8 | 2.2 | 9.2 | 18 | Very good |
| Example 2 | | | | 0.8 | 30 | 0.8 | 2.0 | 10.0 | 21 | Good |
| Example 3 | | | | 1.0 | 30 | 1.5 | 1.5 | 14.8 | 50 | Good |
| Example 4 | | | | 1.0 | 10 | 0.8 | 3.4 | 8.5 | 15 | Very good |
| Example 5 | | | | 1.2 | 10 | 0.8 | 4.2 | 7.9 | 12 | Very good |
| Example 6 | B | 0.6 | 0.025 | 1.0 | 30 | 0.8 | 1.9 | 10.1 | 22 | Good |
| Example 7 | | | | 0.8 | 30 | 0.8 | 1.8 | 11.0 | 25 | Good |
| Example 8 | | | | 1.0 | 30 | 1.5 | 1.4 | 17.2 | 55 | Good |
| Example 9 | | | | 1.0 | 10 | 0.8 | 2.0 | 13.6 | 23 | Good |
| Example 10 | | | | 1.2 | 10 | 0.8 | 2.1 | 17.0 | 24 | Good |
| Comparative | C | 0.8 | Unmeasured | 1.0 | 30 | 0.8 | 1.3 | 9.4 | — | — |
| Example 1 | | | | | | | | | | |
| Comparative | | | | 1.0 | 10 | 0.8 | 1.4 | 10.1 | — | — |
| Example 2 | | | | | | | | | | |
| Comparative | A | 0.4 | 0.025 | 1.0 | 4 × 10⁴ | 0.8 | 1.1 | 16.1 | 112 | Bad |
| Example 3 | | | | | | | | | | |

A mark - in the table means that owing to cleaning fault, image quality was very much deteriorated and evaluation could not be applied.

The image forming apparatus according to the invention and the image forming method therewith provide the following advantage. When the specific resistance of the titanium oxide as the polishing agent is set in the predetermined range, excessive charging in a toner and an air gap can be effectively prevented from occurring while efficiently recovering the residual toner, in a cleaning device, even in the case where the dynamic friction coefficient of a latent image carrier is in the predetermined range. As a result, even when the dynamic friction coefficient of the latent image carrier is in the predetermined range, it is possible to effectively prevent occurrence of black spots caused by the leakage current from the cleaning device, while efficiently recovering the residual toner.

Accordingly, an image forming apparatus according to the invention and the image forming method therewith are expected to largely contribute to an improvement of the image characteristics in various kinds of image forming apparatuses such as a copying machine and a printer.

What is claimed is:

1. An image forming apparatus, comprising:
a cleaning device provided with a rotation member for cleaning a surface of a latent image carrier with a titanium oxide contained in a toner,
wherein a dynamic friction coefficient in the latent image carrier is set to a value in the range of 0.3 to 0.7, and
a specific resistance of the titanium oxide is set to a value in the range of 1×10⁰ to 1×10² Ω·cm.

2. The image forming apparatus according to claim 1, wherein, assuming that a fluorescent X-ray intensity of the titanium oxide in the toner before use is X1 and a fluorescent X-ray intensity of the titanium oxide in the toner in the cleaning device is X2, the X1 and the X2 satisfy a relational expression (1) below.
X2/X1≧1.4 (1)

3. The image forming apparatus according to claim 1, wherein an additional amount of the titanium oxide is set to a value in the range of 0.1 to 5 parts by weight with respect to 100 parts by weight of toner particles.

4. The image forming apparatus according to claim 1, wherein a center line average surface roughness (Ra) of the latent image carrier measured based on JIS B0601 is set to a value in the range of 0.010 to 0.040 μm.

5. The image forming apparatus according to claim 1, wherein the latent image carrier is an amorphous-silicon photoconductor.

6. The image forming apparatus according to claim 1, wherein a toner carried on a surface of the latent image carrier is transferred to a transfer body from its downward position.

7. The image forming apparatus according to claim 1, wherein the cleaning device has a toner receiving member for storing a toner scraped off the latent image carrier.

8. An image forming method, comprising:
a step of cleaning a surface of a latent image carrier with a titanium oxide contained in a toner by use of a rotation member in a cleaning device,
wherein a dynamic friction coefficient in the latent image carrier is set to a value in the range of 0.3 to 0.7, and
a specific resistance of the titanium oxide is set to a value in the range of 1×10⁰ to 1×10² Ω·cm.

9. The image forming method according to claim 8, wherein a toner carried on a surface of the latent image carrier is transferred to a transfer body from its downward position.
